(19) United States
(12) Patent Application Publication
(10) Pub. No.: US 2024/0284522 A1
(43) Pub. Date: Aug. 22, 2024

(54) USER EQUIPMENT COMMUNICATION WITH ASSISTING DEVICES FOR UU LINK ENHANCEMENT

(71) Applicant: QUALCOMM Incorporated, San Diego, CA (US)

(72) Inventors: Sourjya Dutta, San Diego, CA (US); Kapil GULATI, Belle Mead, NJ (US); Mahmoud ASHOUR, San Diego, CA (US); Himaja KESAVAREDDIGARI, Bridgewater, NJ (US); Kyle Chi GUAN, New York, NY (US); Navid ABEDINI, Basking Ridge, NJ (US)

(21) Appl. No.: 18/170,761

(22) Filed: Feb. 17, 2023

(51) Int. Cl. H04W 76/10; H04W 76/20

(52) U.S. Cl. CPC H04W 76/10; H04W 76/20; H04W 88/14

(57) ABSTRACT

Aspects of the present disclosure provide apparatus, methods, processing systems, and computer readable mediums for user equipment (UE) managing of assisting devices for Uu link relay, such as, for example, vehicles equipped with reconfigurable intelligent surfaces (RIS), or UE-controlled repeaters. In some aspects of the disclosure, assisting devices may use sensor-based perception and machine learning capabilities to enhance control of the transmission mode configuration of the assisting device.

### FIELD OF THE DISCLOSURE

Some aspects of the present disclosure generally relate to wireless communications, and more particularly, to techniques for user equipment (UE) communication with assisting devices for Uu link relay, such as, for example, vehicles equipped with reconfigurable intelligent surfaces (RIS), or UE-managed repeaters. In some aspects of the disclosure, assisting devices may use sensor-based perception and machine learning capabilities to enhance control of the transmission mode configuration of the assisting device.

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting wireless communication for multiple communication devices, which may be known as user equipments (UEs). In an LTE or LTE-A network, a set of one or more BSs may define an eNodeB (eNB). In other examples (e.g., in a next generation, a new radio (NR), or 5G network), base stations (BS) for wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., 5G NB, next generation NodeB (gNB or gNodeB), transmission reception point (TRP), etc.). A BS may communicate with a set of UEs on downlink channels (e.g., for transmissions from the BS to the UE) and uplink channels (e.g., for transmissions from the UE to the BS).

These multiple access technologies have been adopted in various telecommunication standards to provide a common protocol that enables different wireless devices to communicate on a municipal, national, regional, and even global level. The NR (e.g., new radio or 5G) is an example of an emerging telecommunication standard. The NR is a set of enhancements to the LTE mobile standard promulgated by 3GPP. The NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, the NR supports beamforming, multiple-input multiple-output (MIMO) antenna technology, and carrier aggregation.

However, as the demand for mobile broadband access continues to increase, there exists a need for further improvements in the NR and the LTE technology. Preferably, these improvements should be applicable to other multi-access technologies and the telecommunication standards that employ these technologies.

### SUMMARY

Aspects of the present disclosure provide for techniques of user equipment (UE) communication with of assisting devices that relay a wireless communication link, denoted as Uu link, that connects the UE and a base station (BS) over the air. The assisting device provides different transmission modes for relaying radio signals between the UE and the base station in uplink and downlink direction. A local communication link between the UE and the assisting device facilitates communication to support management or control of the configuration of the assisting device for relaying Uu link signals. In some aspects, enhanced service is provided by exploiting sensor-based perception and machine learning capabilities of the assisting device.

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that may include desirable communication using assisting devices that relay radio signals associated with an Uu link.

Certain aspects provide a method of wireless communication by a UE, the UE being configured for communicating with an assisting device, the assisting device providing different transmission modes for relaying radio signals associated with a Uu link between the UE and a base station. The method comprises establishing a local communication link between the UE and the assisting device, receiving transmission mode set information associated with a set of one or more active transmission modes of the assisting device and communicating with the assisting device via the local link to select a transmission mode of the assisting device. The method further comprises communicating with the base station via the Uu link relayed by the assisting device based on the selected transmission mode.

Certain aspects provide an apparatus for wireless communications. In some aspects, the apparatus is a user equipment (UE). The apparatus may include at least one processor and a memory. The at least one processor and the memory may be configured for communicating with an assisting device, the assisting device providing different transmission modes for relaying radio signals associated with a Uu link between the apparatus and a base station. The at least one processor and the memory may further be configured to establish a local communication link between the apparatus and the assisting device, to receive transmission mode set information associated with a set of one or more active transmission modes of the assisting device and to communicate with the assisting device via the local link to select a transmission mode of the assisting device. The at least one processor and the memory may further be configured to communicate with the base station via the Uu link relayed by the assisting device based on the selected transmission mode.

Certain aspects provide an apparatus for wireless communications. In some aspects, the apparatus is a user equipment (UE) apparatus. The apparatus may be configured for communicating with an assisting device, the assisting device providing different transmission modes for relaying radio signals associated with a Uu link between the apparatus and a base station. The apparatus may comprise means for establishing a local communication link between the apparatus and the assisting device, means for receiving transmission mode set information associated with a set of one or more active transmission modes of the assisting device, and means for communicating with the assisting device via the local link to select a transmission mode of the assisting device. The apparatus may further comprise means for communicating with the base station via the Uu link relayed by the assisting device based on the selected transmission mode.

Certain aspects provide a non-transitory computer-readable medium storing code for wireless communications. The code may comprise instructions executable by a processor associated with an apparatus configured for communicating with an assisting device, the assisting device providing different transmission modes for relaying radio signals associated with a Uu link between a UE and a base station. The code may furthermore comprise instructions executable by a processor to: establish a local communication link between the apparatus and the assisting device, to receive transmission mode set information associated with a set of one or more active transmission modes of the assisting device, and to communicate with the assisting device via the local link to select a transmission mode of the assisting device. The code may furthermore comprise instructions executable by a processor to communicate with the base station via the Uu link relayed by the assisting device based on the selected transmission mode.

Certain aspects provide a method of wireless communication by an assisting device, the assisting device providing different transmission modes for relaying radio signals associated with a Uu link between a user equipment (UE) and a base station, the method comprising establishing a local communication link between the assisting device and the UE, transmitting transmission mode set information associated with a set of one or more active transmission modes of the assisting device, and communicating with the UE via the local link to select a transmission mode of the assisting device. The method further comprises relaying signals associated with the Uu link between the UE and the base station based on the selected transmission mode.

Certain aspects provide an apparatus for wireless communications. In some aspects, the apparatus may be an assisting device providing different transmission modes for relaying radio signals associated with a Uu link between a user equipment (UE) and a base station. The apparatus may include at least one processor and a memory. The at least one processor and the memory may be configured to establish a local communication link between the apparatus and the UE, to transmit transmission mode set information associated with a set of one or more active transmission modes of the apparatus, to communicate with the UE via the local link, and to select a transmission mode of the apparatus. The at least one processor and the memory may be further configured to relay signals associated with the Uu link between the UE and the base station based on the selected transmission mode.

Certain aspects provide an apparatus for wireless communications. In some aspects, the apparatus may be an assisting device providing different transmission modes for relaying radio signals associated with a Uu link between a user equipment (UE) and a base station. The apparatus may comprise means for establishing a local communication link between the apparatus and the UE, means for transmitting transmission mode set information associated with a set of one or more active transmission modes of the apparatus, and means for communicating with the UE via the local link to select a transmission mode of the apparatus. The apparatus may further comprise means for relaying signals associated with the Uu link between the UE and the base station based on the selected transmission mode.

Certain aspects provide a non-transitory computer-readable medium storing code for wireless communications. The code may comprise instructions executable by a processor associated with an apparatus for wireless communications. In some aspects, the apparatus may be an assisting device providing different transmission modes for relaying radio signals associated with a Uu link between a user equipment (UE) and a base station. The code may furthermore comprise instructions executable by a processor to: establish a local communication link between the apparatus and the UE, to transmit transmission mode set information associated with a set of one or more active transmission modes of the apparatus, and to communicate with the UE via the local link to select a transmission mode of the apparatus. The code may further comprise instructions executable by a processor to relay signals associated with the Uu link between the UE and the base station based on the selected transmission mode.

To the accomplishment of the foregoing and related ends, the one or more aspects including the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless system, in accordance with certain aspects of the present disclosure.

FIG. 2 illustrates an example application of an assisting device based on reconfigurable intelligent surfaces (RIS) in an automotive use case in accordance with aspects of the present disclosure.

FIG. 3 illustrates an example application of how layer 1 (L1) relays, such as smart repeaters, may be used to help improve coverage by overcoming blockage, in accordance with aspects of the present disclosure.

FIG. 4 shows an example architecture for a L1 relay in accordance with aspects of the present disclosure.

FIG. 5 illustrates an example application of an assisting device based on a smart repeater in accordance with aspects of the present disclosure.

FIG. 6 illustrates example operations that may be performed by a UE being configured for communicating with and assisting device, in accordance with certain aspects of the present disclosure.

FIG. 7 illustrates example operations that may be performed by an assisting device, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

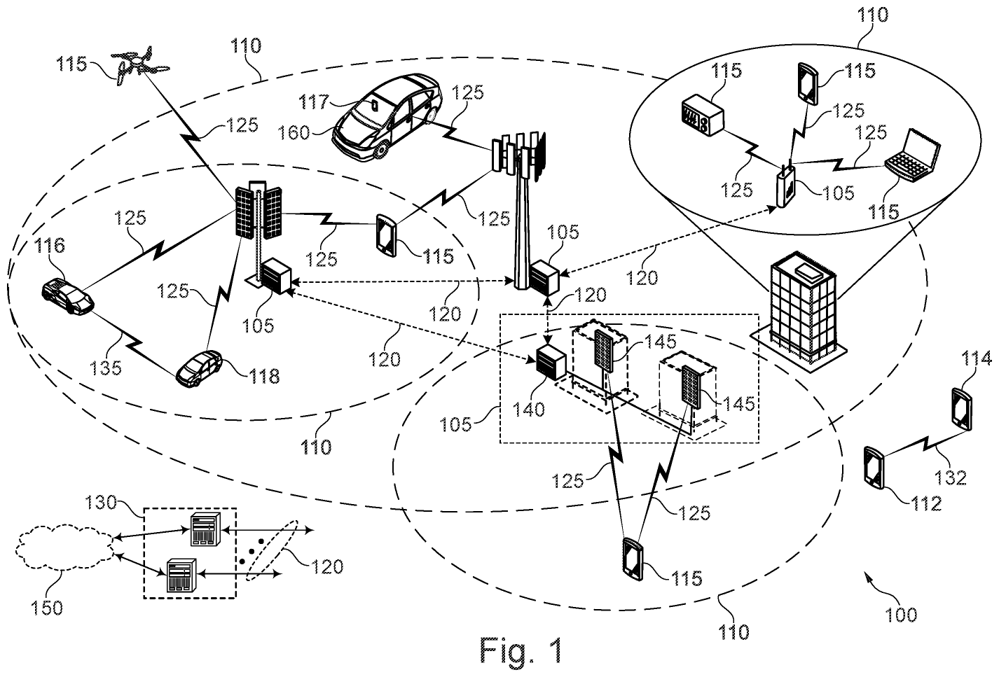

FIG. 1 illustrates an example of a wireless communications system 100 that supports methods accordance with aspects of the present disclosure. The wireless communications system 100 may include base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (for example, mission critical) communications, low latency communications, communications with low-cost and low-complexity devices, or any combination thereof.

Base stations 105 may be dispersed throughout a geographic area to form the wireless communications system 100 and may be devices in different forms or having different capabilities. In some aspects, the term “base station” (e.g., the base station 105) or “network node” or “network entity” may be used interchangeably, and may refer to an aggregated base station, a disaggregated base station, an integrated access and backhaul (IAB) node, a relay node, and/or one or more components thereof. For example, in some aspects, “base station,” “network node,” or “network entity” may refer to a Central Unit (CU), a Distributed Unit (DU), a Radio Unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 105. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

Base stations 105 and UEs 115 may wirelessly communicate via one or more communication links 125. For an NR system, the NR-Uu interface connects a UE 115 (e.g., a 5G NR-capable UE) to a base station (such as a gNB) over the air. In some examples, communication link 125 may thus be a Uu link, such as an NR-Uu link. For an LTE system, the LTE-Uu interface connects a UE 115 (e.g., an LTE-capable UE) with a base station. In some examples, communication link 125 may thus be a Uu link, such as an LTE-Uu link. Each base station 105 may provide a coverage area 110 over which UEs 115 and the base station 105 may establish communication links 125. The coverage area 110 may be an example of a geographic area over which a base station 105 and a UE 115 support the communication of signals according to one or more radio access technologies. In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, overlapping geographic coverage areas 110 associated with different technologies may be supported by different base stations 105. The wireless communications system 100 may include, for example, a heterogeneous network in which different types of base stations 105 provide coverage for various geographic coverage areas 110 using the same or different radio access technologies.

Each base station 105 may provide communication coverage via one or more cells, for example a macro cell, a small cell, a hot spot, or other types of cells, or various combinations thereof. The term “cell” may refer to a logical communication entity used for communication with a base station 105 (for example, over a carrier) and may be associated with an identifier for distinguishing neighboring cells (for example, a physical cell identifier (PCID), a virtual cell identifier (VCID), or others). In some examples, a cell may also refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the base station 105. For example, a cell may be or include a building, a subset of a building, exterior spaces between or overlapping with geographic coverage areas 110, among other examples.

A macro cell generally covers a relatively large geographic area (for example, several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (for example, licensed, unlicensed) frequency spectrum bands as macro cells. Small cells may provide unrestricted access to UEs 115 with service subscriptions with the network provider or may provide restricted access to UEs 115 having an association with the small cell (for example, UEs 115 in a closed subscriber group (CSG), UEs 115 associated with users in a home or office, among other examples). A base station 105 may support one or multiple cells and may also support communications over the one or more cells using one or multiple component carriers.

One or more of base stations 105 may include or may be referred to by a person of ordinary skill in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or other suitable terminology. A gNB may comprise a gNB Central Unit (gNB-CU) and one or more gNB Distributed Units (gNB-DUs). The gNB-CU terminates the F1 interface connected with the gNB-DU. The operation of a gNB-DU is partly controlled by gNB-CU. One gNB-DU may support one or multiple cells. One cell may be supported by one gNB-DU.

UEs 115 may be dispersed throughout a coverage area 110 of the wireless communications system 100, and each UE 115 may be stationary, or mobile, or both at different times. UEs 115 may be devices in different forms or having different capabilities. Some example UEs 115 are illustrated with reference to FIG. 1. The UEs 115 may be able to communicate with various types of devices, such as other UEs 115, base stations 105, or network equipment (for example, core network nodes, relay devices, integrated access and backhaul (IAB) nodes, or other network equipment), as shown with reference to FIG. 1.

Base stations 105 may communicate with the core network 130, or with one another, or both. For example, base stations 105 may interface with the core network 130 through backhaul links 120 (for example, via an S1, N2, N3, or other interface). Base stations 105 may communicate with one another over backbone links 120 (for example, via an X2, Xn, or other interface) either directly (for example, directly between base stations 105), or indirectly (for example, via core network 130), or both. In some examples, backhaul links 120 may be or include one or more wireless links.

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, meters, among other examples.

The UEs 115 may be able to communicate with various types of devices, such as other UEs 115 that may sometimes act as relays as well as base stations 105 and network equipment including macro eNBs or gNBs, small cell eNBs or gNBs, or relay base stations, among other examples, as shown with reference to FIG. 1. UEs 115 and base stations 105 may wirelessly communicate with one another via one or more communication links 125 over one or more carriers. In some examples, a carrier may support multiple cells, and different cells may be configured according to different protocol types (for example, machine type communications (MTC), narrowband IoT (NB-IoT), enhanced mobile broadband (eMBB), or others) that may provide access for different types of devices. The term “carrier” may refer to a set of radio frequency spectrum resources having a defined physical layer structure for supporting communication links 125. For example, a carrier used for a communication link 125 may include a portion of a radio frequency spectrum band that is operated according to physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. In some examples, the receive and transmit band of a UE 115 may not need be as large as the bandwidth of the cell and may be adjusted in a process which may be referred to as bandwidth adaptation (BA), i.e., the width may be ordered to change (e.g., to shrink during period of low activity to save power), the location may move in the frequency domain (e.g., to increase scheduling flexibility), and the subcarrier spacing may be ordered to change (e.g., to allow different services). A subset of the total cell bandwidth of a cell may be referred to as bandwidth part (BWP) and BA may be achieved by configuring the UE with BWP(s) and telling the UE which of the configured BWPs is currently the active one.

The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by UEs 115. A carrier may be operated in a standalone mode in which initial acquisition and connection may be conducted by UEs 115 via the carrier, or the carrier may be operated in a non-standalone mode in which a connection is anchored using a different carrier (for example, of the same or a different radio access technology).

Communication links 125 shown in the wireless communications system 100 may include uplink transmissions from a UE 115 to a base station 105, or downlink transmissions from a base station 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, base stations 105, UEs 115, or both) may have hardware configurations that support communications over a particular carrier bandwidth or may be configurable to support communications over one of a set of carrier bandwidths. In some examples, the wireless communications system 100 may include base stations 105 and UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, in which the symbol period and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, in which a numerology may include a subcarrier spacing (Δf) and a cyclic prefix. A carrier may be divided into BWPs having the same or different numerologies. In some examples, a UE 115 may be configured with multiple BWPs. In some examples, a single BWP for a carrier is active at a given time, and communications for the UE 115 may be restricted to active BWPs. Time intervals for base stations 105 or UEs 115 may be expressed in multiples of a basic time unit which may, for example, refer to a sampling period of Tₛ=1/(Δfₘₐₓ·N_{f}) seconds, in which Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency spectrum band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol periods in a TTI) may be variable. Additionally, or alternatively, the smallest scheduling unit of the wireless communications system 100 may be dynamically selected (for example, in bursts of shortened TTIs (STTIs)).

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of UEs 115. For example, the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception simultaneously). In some examples, half-duplex communications may be performed at a reduced peak rate. Other power conservation techniques for UEs 115 include entering a power saving deep sleep mode when not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE, such as UE 112, 114, 116, 117 and 118, may also be able to communicate directly with other UEs over a device-to-device (D2D) communication link 132, 135 (for example, using a peer-to-peer (P2P) or D2D protocol). One or more UEs, such as UEs 116 and UE 118 utilizing D2D communications may be within the geographic coverage area 110 of a base station 105 to communicate via a D2D communication link 135. Other UEs, such as UE 112 and UE 114 may be outside the geographic coverage area 110 of a base station 105 or be otherwise unable to receive transmissions from a base station 105 to communicate via D2D communication link 132. In some examples, groups of UEs 112, 114, 116, 118 communicating via D2D communications may utilize a one-to-many (1:M) system in which each UE 112, 114, 116, 118 transmits to every other UE in the group. In some examples, a base station 105 facilitates the scheduling of resources for D2D communications, such as D2D communications between UE 116 and UE 118. In other examples, D2D communications are carried out between UEs without the involvement of a base station 105, as for the D2D communications between UE 112 and UE 114.

In some aspects, the D2D communication link 135 may be an example of a sidelink communication channel. Unlike a Uu link, which is the link over the air between a UE (such as UE 115) and a base station, a sidelink is associated with the link over the air directly between UEs 115 (for example, UEs 112, 114, 116 and 118). Real-world applications of such sidelink communications may include public safety, proximity services, UE-to-network relaying, vehicle-to-vehicle (V2V) communications, vehicle to everything (V2X) communications, Internet of Everything (IoE) communications, IoT communications, mission-critical mesh, and/or various other suitable applications, such as communication with vehicles equipped with reconfigurable intelligent surfaces (RIS), or a UE-managed (or controlled) repeater. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, base stations 105) using vehicle-to-network (V2N) communications, or with both. Generally, a sidelink may refer to signals communicated from one sidelink device (e.g., UE 112, 116) to another sidelink device (e.g., UE 114, 118) without relaying that communication through the scheduling entity (e.g., UE or base station), even though the scheduling entity may be utilized for scheduling and/or control purposes. In some examples, the sidelink signals may be communicated using a licensed spectrum (unlike wireless local area networks, which typically use an unlicensed spectrum). While some UEs may only be configured to communicate with a base station on an Uu link, there may be UEs (such as UEs 114 and 118) that are configured to communicate with a base station on an Uu link, and with other devices over a sidelink, as well (e.g., simultaneously).

In some aspects, the UEs 112, 114, 116, 118 may optionally be configured to perform beam management procedures for a sidelink. Accordingly, one or more of the UEs may function as a scheduling entity in a device-to-device (D2D), peer-to-peer (P2P), or vehicle-to-vehicle (V2V) network, and/or in a mesh network to initiate and/or schedule certain beam management procedures.

In some aspects, sidelink communications may be used to provide a local communication link between a UE and an assisting device for relaying Uu link radio signals. For example, a repeater (sometimes denoted as a smart repeater) may be configured to amplify and forward signals associated with a Uu link between a UE and a base station (e.g., a gNB), while it is configured to transmit and receive control signals on the local communication link. The control signals may be used to control the amplify and forward process performed at the repeater by a UE that terminates the Uu link. In some examples, a local communication link may be provided by wireless communication techniques, such as Bluetooth, ZigBee, or Wi-Fi. In other aspects, a UE, such as UE 117 may apply techniques for communicating with transmissive or reflective reconfigurable intelligent surfaces (RIS). In an example automotive use case, a UE 117 located in a vehicle 116 may communicate via a local communication link a RIS controller. The RIS controller of the vehicle may control the front, side, back, and sunroof screens designed as transmissive RIS to boost signal strength of a communication link 125 (e.g., a Uu link) between the UE 117 and a base station.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), a user plane function (UPF)). The control plane entity may manage non-access stratum (NAS) functions such as mobility, authentication, and bearer management for UEs 115 served by base stations 105 associated with the core network 130. User IP packets may be transferred through the user plane entity, which may provide IP address allocation as well as other functions. The user plane entity may be connected to the network operators IP services 150. The operators IP services 150 may include access to the Internet, an Intranet, an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with UEs 115 through a number of other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more radio frequency spectrum bands, typically in the range of 300 megahertz (MHz) to 300 gigahertz (GHz). Generally, the region from 300 MHz to 3 GHz is known as the ultra-high frequency (UHF) region or decimeter band, as the wavelengths range from approximately one decimeter to one meter in length. UHF waves may be blocked or redirected by buildings and environmental features, but the waves may penetrate structures sufficiently for a macro cell to provide service to UEs 115 located indoors. Transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using radio frequency spectrum bands from 3 GHz to 30 GHZ, also known as the centimeter band, or in an extremely high frequency (EHF) region of the spectrum (for example, from 30 GHz to 300 GHz), also known as the millimeter band. In some examples, the wireless communications system 100 may support millimeter wave (mmW) communications between UEs 115 and base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or UE 115 may be equipped with multiple antennas, which may be used to employ techniques such as transmit diversity, receive diversity, multiple-input multiple-output (MIMO) communications, or beamforming. The antennas of a base station 105 or UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), in which multiple spatial layers are transmitted to the same receiving device, and multiple-user MIMO (MU-MIMO), in which multiple spatial layers are transmitted to multiple devices.

Beamforming, which may also be referred to as spatial filtering, directional transmission, or directional reception, is a signal processing technique that may be used at a transmitting device or a receiving device (for example, a base station 105 or a UE 115) to shape, direct, or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or a receiving device, such as a UE 115) a beam direction for subsequent transmission and reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in different beam directions. For example, a UE 115 may receive one or more of the signals transmitted by the base station 105 in different directions and may report to the base station 105 an indication of the signal that the UE 115 received with a highest signal quality, or an otherwise acceptable signal quality.

In some examples, transmissions by a device (for example, by a base station 105 or UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for determining a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

As part of directional communications, the one or more of the base stations 105 or the UEs 115 may support beam management for one or more downlink receive directional beams corresponding to one or more physical downlink channels or one or more uplink transmit directional beams corresponding to one or more physical uplink channels. In some examples, beam management may include performing a beam switch from one or more downlink receive directional beams to one or more alternative downlink receive directional beams, or from one or more uplink transmit directional beams to one or more alternative uplink transmit directional beams to improve communications between the one or more of the base stations 105 or the UEs 115 or between the different UEs 115. In some examples, the alternative directional beams may have a better (or higher) signal quality, such as one or more of a higher reference signal received power (RSRP), a smaller SNR, or a smaller signal to interference and noise ratio (SINR), as compared to existing directional beams used by one or more of the base stations 105 or the UEs 115.

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

UEs 115 and base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which the device may provide HARQ feedback in a specific slot for data received in a previous symbol in the slot. In other examples, the device may provide HARQ feedback in a subsequent slot, or according to some other time interval.

One or more of base stations 105 or UEs 115 may support directional communications in the wireless communications system 100. Directional communications may include one or more downlink receive directional beams corresponding to one or more physical downlink channels or one or more uplink transmit directional beams corresponding to one or more physical uplink channels. The one or more physical downlink channels may include one or more of a physical downlink control channel (PDCCH), a physical downlink shared channel (PDSCH) or a synchronization signal physical broadcast channel (SS/PBCH) block, and the one or more physical uplink channels may include one or more of a physical uplink control channel (PUCCH) or a physical uplink shared channel (PUSCH). In some examples, the one or more of the base stations 105 or the UEs 115 may perform a beam sweep procedure to determine and select one or more downlink receive directional beams and one or more uplink transmit directional beams to establish a connection.

In some examples, the one or more of the base stations 105 or the UEs 115 may support directional communications in one or more radio frequency spectrum bands. In some examples, a radio frequency spectrum band may be defined by a range of radio frequencies (f) within the radio frequency spectrum band. For example, a first frequency range (FR1) may have a frequency range between 410 MHz and 7.125 GHz (410 MHz<f<7.125 GHz), a second frequency range (FR2) may have a different frequency range from FR1, for example, between 24.25 GHz and 52.6 GHz (24.25 GHz<f<52.6 GHz), while a third frequency range (FR3) may have a different frequency range from FR1 and FR2, for example, between 7.125 GHz and 24.25 GHZ (7.125 GHz<f<24.25 GHz). In some examples, one or more of FR1, FR2, or FR3 may be referred to as a low radio frequency spectrum band. As such, in some examples, the one or more of the base stations 105 or the UEs 115 may support directional communications in low radio frequency spectrum bands.

Additionally, or alternatively, the one or more of the base stations 105 or the UEs 115 may support directional communications in one or more high radio frequency spectrum bands. A high radio frequency spectrum band may refer to a radio frequency spectrum band that is greater than or equal to a frequency (f) (for example, greater than 52.6 GHz). In some examples, a radio frequency spectrum band including frequencies between 52.6 GHz and 114.25 GHz (52.6 GHz<f<114.25 GHZ) may be referred to as a fourth frequency range (FR4), while a radio frequency spectrum band including frequencies between 114.25 GHz and 275 GHz (114.25 GHz<f<275 GHz) may be referred to as a fifth frequency range (FR5). Therefore, FR4 and FR5 may be referred to as high radio frequency spectrum bands.

Each radio frequency spectrum band, such as FR1, FR2, FR3, FR4 and FR5 may relate to a transmission numerology. Table 1 below defines examples of different transmission numerologies. In some examples, the one or more of the base stations 105 or the UEs 115 may support one or more transmission numerologies as defined in Table 1. Each numerology in Table 1 may be labeled as a parameter μ. In some examples, the numerology may be based on exponentially scalable subcarrier spacing Δf=2^{μ}×15 kHz with μ={0,1,2,3,4}. As defined in Table 1, a numerology (μ=0) represents a subcarrier spacing of 15 kHz. Among other examples, as defined in Table 1, numerology (μ=1) represents a subcarrier spacing of 30 kHz, numerology (μ=2) represents a subcarrier spacing of 60 kHz, numerology (μ=3) represents a subcarrier spacing of 120 kHz, and numerology (μ=4) represents a subcarrier spacing of 240 kHz.

TABLE 1
Transmission Numerologies.

| | | | Supported for | Supported for |
|---|---|---|---|---|
| μ | Δf = 2^{μ} · 15 [kHz] | Cyclic Prefix | Data | Synch |
| 0 | 15 | Normal | Yes | Yes |
| 1 | 30 | Normal | Yes | Yes |
| 2 | 60 | Normal, | Yes | No |
| | | Extended | | |
| 3 | 120 | Normal | Yes | Yes |
| 4 | 240 | Normal | No | Yes |

By way of example, radio frequency spectrum band FR1 may relate to transmission numerologies μ={0,1,2}. For example, radio frequency spectrum band FR1 may support subcarrier spacings of 15 kHz, 30 kHz, and 60 kHz, which may correspond to a symbol duration of approximately 71 microseconds (μs), 36 μs, and 18 μs, respectively. The symbol duration (for example, approximately 71 μs, 36 μs, and 18 μs) may include a duration of a cyclic prefix of the symbol. The base stations 105 or the UE 115 may prepend a cyclic prefix to each symbol to improve transmission of the symbol. A cyclic prefix may represent a guard period at a beginning of each symbol that may improve transmission reliability of the symbol by providing protection against one or more factors in the wireless communications system 100, such as multipath delay spread. Among other examples, radio frequency spectrum band FR2 may relate to transmission numerologies μ={2,3,4}. For example, radio frequency spectrum band FR2 may support subcarrier spacings of 60 kHz, 120 kHz, and 240 kHz, which may correspond to symbol durations of approximately 18 μs, 9 μs, and 4.5 μs, respectively. Similarly, the symbol duration (for example, approximately 18 μs, 9 μs, and 4.5 μs) may include a duration of a cyclic prefix for the symbol.

In some examples, as shown in Table 1, a duration of a cyclic prefix may depend on the transmission numerology. That is, a duration of a cyclic prefix may be shorter or greater in length based on the transmission numerology. For example, a cyclic prefix may have a duration of 4.7 us for a 15 kHz subcarrier spacing (for example, numerology μ=0), and 0.57 us for a 120 kHz subcarrier spacing (for example, numerology μ=3). In some examples, as defined in Table 1, a normal cyclic prefix may be supported for each subcarrier spacing (for example, for each transmission numerology), while an extended cyclic prefix may be supported exclusively for numerology μ=2. A normal cyclic prefix may be shorter in length compared to an extended cyclic prefix. For example, a normal cyclic prefix may have a duration of 4.7 μs, while an extended cyclic prefix may have a duration of 16.7 μs. As demand for communication efficiency increases, the wireless communications system 100 may support larger subcarrier spacings for one or more high radio frequency spectrum bands (for example, FR4 and FR5). Some examples of the wireless communications system 100 may support one or more of subcarrier spacings of 480 kHz, 960 kHz, 1.92 MHz, or 3.84 MHz for one or more high radio frequency spectrum bands (for example, FR4 and FR5). However, the wireless communications system 100 is not limited to the above examples of subcarrier spacings (for example, 480 kHz, 960 kHz, 1.92 MHz, or 3.84 MHZ), as other subcarrier spacings may be supported in the wireless communications system 100.

In some examples, for radio frequency spectrum band FR2, the base stations 105 or the UEs 115 may support a 240 kHz subcarrier spacing exclusively for synchronization signal blocks (SSBs). In general, the term “SSB” may commonly refer to a synchronization signal and PBCH block. The SSB may span across four OFDM symbols and may comprise the primary synchronization signal (PSS), the secondary synchronization signal (SSS) and the PBCH. The PSS and SSS may occupy each one OFDM symbol and 127 subcarriers, while the PBCH may span across three OFDM symbols and 240 subcarriers but leaving an unused range of 127 subcarriers in the middle for the SSS in one of the three OFDM symbols. The periodicity of the SSB may be configurable by the network and the time locations where SSB can be sent may be determined by subcarrier spacing. In some examples, within the frequency span of a carrier, multiple SSBs may be transmitted, and the physical cell identifiers (PCIs) of those SSBs do not have to be unique, i.e., different SSBs may have different PCIs. However, in some examples, when an SSB is associated with remaining minimum system information (RMSI), the SSB may correspond to an individual cell, which may have a unique NR cell global identifier (NCGI). Such an SSB may then be referred to as a cell-defining SSB (CD-SSB).

In related aspects, the term “global channel raster” may refer to a set of radio frequency (RF) reference frequencies, wherein a RF reference frequency may be used in signaling to identify the position of RF channels, SSBs, and other elements in a wireless communication system, such as NR. In particular, RF frequencies may be designated by an NR Absolute Radio Frequency Channel Number (NR-ARFCN) on the global frequency raster. In some examples, the global frequency raster may be defined for all frequencies from 0 to 100 GHz with a granularity denoted as AFGlobal, which may depend on a frequency range. For example, AFGlobal may be equal to 5 kHz in a frequency range from 0 to 3 GHZ, 15 kHz in a frequency range from 3 GHz to 24.25 GHz, and 60 kHz and in a frequency range from 24.25 GHz to 100 GHz. In other related aspects, the term “channel raster” may refer to a set of RF reference frequencies FREF that may be used to identify the RF channel position in the uplink and downlink. The RF reference frequency for an RF channel may map to a resource element on a carrier. For each operating band, which may be predefined, only a subset of frequencies from the global frequency raster may be applicable for that band and may form a channel raster with a granularity ΔF_{Raster}, which may be equal to or larger than ΔF_{Global}.

In some related aspects, the term “synchronization raster” may be used to refer to the frequency positions of the SSB, that can be used by the UE for system acquisition when explicit signaling of the SSB position is not present. A global synchronization raster may be defined for all frequencies. For example, in a wireless communication system such as NR, the frequency position of the SSB may be defined as SS_{REF} with corresponding Global Synchronization Channel Number (GSCN). The synchronization raster and the subcarrier spacing of the SSB may be defined separately for each operating band, which may therefore be regarded as a plurality of different synchronization rasters. In some examples, the operating bands may correspond to those defined in Table 2 for NR FR2.

TABLE 2
NR operating bands in FR2

| | Uplink (UL) operating | Downlink (DL) operating | |
|---|---|---|---|
| | band | band | |
| | BS receive | BS transmit | |
| Operating | UE transmit | UE receive | Duplex |
| Band | F_{UL}_{_{—}}_{low}-F_{UL}_{_{—}}_{high} | F_{DL}_{_{—}}_{low}-F_{DL}_{_{—}}_{high} | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 39500 MHz-43500 MHz | 39500 MHz-43500 MHz | TDD |
| n260 | 37000 MHz-40000 MHz | 37000 MHz-40000 MHz | TDD |
| n261 | 27500 MHz-28350 MHz | 27500 MHz-28350 MHz | TDD |

In some examples, the synchronization raster for each operating band shown in Table 2 may be defined as indicated in Table 3, wherein the distance between GSCN entries may be given by the <Step size>. The SSB pattern may correspond either to Case D (SCS: 120 kHz, the first symbols of the candidate SS/PBCH blocks have indexes {4, 8, 16, 20}+28·n, with n=0, 1, 2, 3, 5, 6, 7, 8, 10, 11, 12, 13, 15, 16, 17, 18 for carrier frequencies within FR2) or to Case E (SCS: 240 kHz, the first symbols of the candidate SS/PBCH blocks (SSBs) have indexes {8, 12, 16, 20, 32, 36, 40, 44}+56·n, with n=0, 1, 2, 3, 5, 6, 7, 8 for carrier frequencies within FR2).

TABLE 3
Applicable SS raster entries per operating band.

| NR | | | |
|---|---|---|---|
| Operating | | | Range of GSCN |
| Band | SSB SCS | SSB pattern | (First-<Step size>-Last) |
| n257 | 120 kHz | Case D | 22388-<1>-22558 |
| | 240 kHz | Case E | 22390-<2>-22556 |
| n258 | 120 kHz | Case D | 22257-<1>-22443 |
| | 240 kHz | Case E | 22258-<2>-22442 |
| n259 | 120 kHz | Case D | 23140-<1>-23369 |
| | 240 kHz | Case E | 23142-<2>-23368 |
| n260 | 120 kHz | Case D | 22995-<1>-23166 |
| | 240 kHz | Case E | 22996-<2>-23164 |
| n261 | 120 kHz | Case D | 22446-<1>-22492 |
| | 240 kHz | Case E | 22446-<2>-22490 |

In further related aspects, the term “cell search” may refer to a procedure for a UE to acquire time and frequency synchronization with a cell and to detect the Cell ID of the cell. For example, NR cell search may be based on PSS, SSS and PBCH demodulation reference signal (PBCH DMRS) located on the synchronization raster. In some examples, a PCell may always be associated to a CD-SSB located on the synchronization raster.

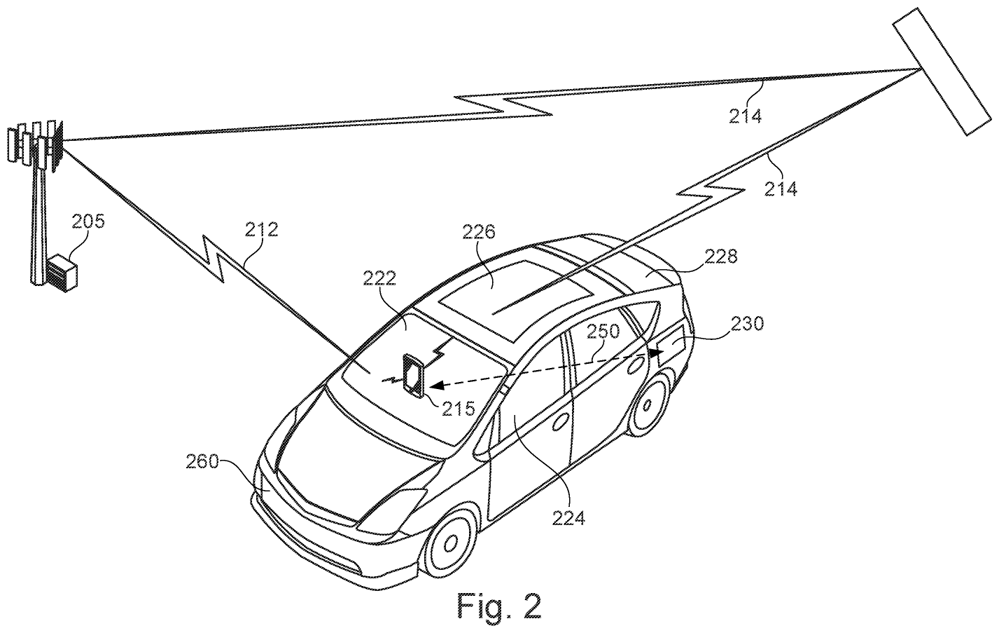

FIG. 2 illustrates an example application of an assisting device based on reconfigurable intelligent surfaces (RIS) in an automotive use case in accordance with aspects of the present disclosure. In this automotive example, a front screen 222, a left side screen 224, a sunroof screen 226, a back screen 228, and a right side screen (not visible in FIG. 2) may be designed as transmissive RIS. The RIS may be controlled by a vehicle built-in RIS controller 230. In some aspects, RIS controller 230 serves to boost signal strength of a communication link (e.g., a Uu link) between a UE 215 located in the vehicle and a base station 205.

In this respect, RIS controller 230 may be communicatively coupled (e.g., by a communication node comprising a transceiver system) with UE 215 via a local communication link 250. The local communication link may be provided by wireless communication techniques, such as sidelink communications as specified in the 3GPP specifications, Bluetooth, ZigBee, an IEEE 802.11 technology, or other suitable technology.

An RIS includes artificial planar structures with integrated electronic circuits that can be programmed to manipulate the incoming electromagnetic field in a wide variety of functionalities. For example, a large number of small-sized active or passive elements of an RIS forming a metasurface may be configured (e.g., by changing the amplitude, and/or by inducing phase shifts) to modify an incident signal. For example, the RIS elements can interact in such a way that they direct and/or focus an incident signal towards a specific direction. RIS may work in full duplex mode independent from the signal direction (e.g., uplink and/or downlink).

In some examples, RIS elements may be installed on transparent substrates such as glass to form an optically transparent metasurface, as illustrated e.g., in Kitayama et al., “Transparent dynamic metasurface for a visually unaffected reconfigurable intelligent surface: controlling transmission/reflection and making a window into an RF lens”, Opt Express, vol. 30, no. 29, 18 Aug. 2021. While being transparent to visible light, the RIS elements within a metasurface may be implemented to form RF lenses having a different number of focal points and focal distances for certain RF frequency bands.

In the present automotive example, metasurfaces of an RIS may be placed on screens of a vehicle, as shown in FIG. 2. In an exemplary example, RIS metasurfaces 222, 224, 226 and 228 may be installed on the front screen, the left side screen, the sunroof screen and the rear screen, respectively. A further RIS metasurface may be installed on a right side screen of the vehicle (not shown in FIG. 2). It should be noted that the use of RIS placed on optically transparent screens is only an example that should not be considered as limiting. As another example, additionally or alternatively, parts of the vehicle bodywork that are not transparent to visible light may be designed as RIS surfaces. These areas may be transparent to RF signals (e.g. parts of a polymer body) and/or reflective to RF signals (e.g. an engine hood).

The metasurfaces built in the vehicle 260 may be part of an assisting device that facilitates relaying of radio signals associated with an Uu link between a UE (e.g. UE 215 located in the vehicle 260) and a base station (e.g., base station 205) in uplink and downlink direction. In some aspects, configuration of the assisting device may be controlled by the UE via a wireless local link between the UE and the assisting device. In some aspects, this may include the UE making use of enhanced services based on sensor-based perception and machine learning capabilities provided by the assisting device. In the present example, the assisting device is a vehicular assisting device. Other examples of assisting devices may include UE-controlled repeaters performing repeater-sided beamforming on the backhaul part of the Uu link towards a base station, in communication with a UE that is connected to the repeater via a wireless link, e.g., a sidelink.

Further with the present automotive example, the propagation paths associated with the Uu link may include a line-of-sight component 212 that propagates through front screen 222, and a reflected component 214 that propagates through rooftop screen 226. In the present example, the vehicular assisting device may further include RIS controller 230 that controls different RIS states of the metasurfaces and provides a local communication channel 250 with UE 215.

A finite number of amplitude and/or phase shift stages may provide a quantized set of available states per RIS metasurface. In this way, a single control signal having defined control states may be usable to control a metasurface of a RIS, rather than requiring a two-dimensional signal for controlling each of the RIS elements. For example, each of the RIS surfaces (such as metasurfaces 222, 224, 226, 228, and a further one placed on the right side of the vehicle, not shown in FIG. 2) may provide a RIS state in which signals are directed/focused towards one or more first focal areas, while in a second RIS state, signals are directed/focused towards one or more second focal areas. In some examples, additionally or alternatively, RIS states may be associated with different diffraction angles of an RF signal. Furthermore, one of the RIS states may be associated with blocking an incoming RF signal.

The combination of different quantized states of one or more RIS metasurfaces may form a set of possible transmission modes of the vehicular assisting device. For the example given in FIG. 2, each of the front 222, left side 224, rooftop 226, rear 228 and right side metasurfaces may be configurable with a first and second RIS state. Thus, in the present example, the vehicular assisting device including the five metasurfaces may provide a set of 25=32 different transmission modes for relaying radio signals. It should be noted that the example is not limiting in terms of the number of metasurfaces or the number of RIS states associated with each metasurface.

UE 215 located within vehicle 260 may experience a signal quality (e.g., RSRP, SNR, SINR, etc.) dependent on the transmission mode that applies. In particular, signal quality may be improved compared to conventional surfaces that do not direct or focus the signals in a configurable manner, when UE 215 is located within a focal area of one or more of the metasurfaces. Signal quality thus depends on the location of UE 215 within the vehicle, and on the propagation paths between the vehicle and base station 205. Hence, in a propagation scenario, a specific transmission mode may be optimal, while in other scenarios (e.g., different propagation paths between the UE and the base station, and/or a different location of the UE within the vehicle), different transmission modes may be optimal.

In the automotive example associated with FIG. 2, the transmission modes to be used by RIS controller 230 may be managed by UE 215 through local communication link 250. For example, UE 215 may use the wireless local communication link 250 to configure the vehicle RIS controller 230 of the vehicular assisting device with measurement intervals for measurements that are to be performed on the Uu link between UE 215 and base station 205. UE 215 may perform signal quality measurements on the Uu downlink based on measurement signals transmitted from the base station. Additionally or alternatively, base station 205 may perform signal quality measurements based on uplink signals transmitted by UE 215. To perform such measurements, the vehicular assisting device may switch (or sweep) through different transmission modes during the configured measurement intervals.

It should be noted that from the viewpoint of the communications network, a UE (such as UE 215) in combination with an assisting device (such as the vehicular assisting device illustrated in FIG. 2) may use the same procedures as known by persons skilled in the art for UE's that perform management of UE-sided beams (e.g., P1, P2 and P3 procedures). However, in difference to managing its UE-sided beams, a UE according to the present disclosure may manage switching or sweeping of transmission modes of an assisting device for relaying radio signals associated with a Uu link between the UE and a base station.

For example, in a P1 procedure, a UE may initially find a TX beam at the base station and an appropriate transmission mode of the assisting device. To this end, the UE may listen to SSB bursts transmitted by the base station while sweeping through the set of transmission modes. The UE thereby configures the assisting device to sweep through transmission modes, and measures the SSB bursts transmitted by the base station within the respective time intervals. In this way, the UE may identify a preferred transmission mode of the assisting device and a preferred SSB beam transmitted by the base station. The UE may then communicate the transmission mode to the assisting device via the local link, and perform a RACH procedure on the Uu link.

In a P2 procedure, the UE may receive from the base station a configuration of TX beam sweep of multiple base station beams. This may include a configuration of channel state information reference signals (CSI-RS) that are used on corresponding beams. The UE measures the configured CSI-RS and reports the Layer 1 reference signal received power (L1-RSPS) to the base station. This procedure may be transparent to the assisting device.

The UE may further exploit a P3 procedure to adapt or refine the transmission mode of the assisting device. To this end, the UE may optionally request from the base station a configuration of repeatedly (e.g., periodically) transmitted beams from the base station. The base station may trigger a measurement of one or more TX beams, where for each TX beam the corresponding reference signals are repeatedly transmitted from the base station. The UE may determine corresponding measurement intervals and transmission modes to be measured and configure the assisting device to use the determined transmission modes during the determined measurement intervals. The UE may perform the measurements of the signal transmitted by the base station while sweeping through the different transmission modes of the assisting device.

It should be noted that by performing measurements of the channel between the UE and the base station, the RIS metasurfaces in their respective configuration are part of the measured channel. Therefore, with the measurement procedures according to the disclosure, it is not necessary to measure or model the propagation properties of the RIS, or to separately consider a base station-RIS channel and a RIS-UE channel.

Referring back to FIG. 2, as mentioned, the vehicular assisting device including the five metasurfaces may provide a set of 25=32 different transmission modes for relaying radio signals. However, in the scenario of FIG. 2, signal quality may in particular depend on the combination of propagation states of metasurfaces 222 and 226, while the propagation states of the other metasurfaces may only have minor influence. Therefore, the determination of optimal RIS settings may have a high overhead.

In order to reduce the overhead, it may not be useful to consider all possible transmission modes of a vehicular assisting device, but only a subset thereof. In an example, it may be useful to reduce the number of possible transmission modes (32 in the example of FIG. 2) to a number of transition modes relevant for a present propagation scenario. In the present automotive example, the only the RIS states associated with front screen 222 and with the sunroof screen 226 may be relevant. The other RIS metasurfaces of the vehicle may be less relevant, and may be set to a default value.

Therefore, in some aspects of the present disclosure, the assisting device may determine a set of one or more active transmission modes of the assisting device. Said set of one or more active transmission modes may include all possible transmission modes (i.e., 32 in the example of FIG. 2). In some specific aspects, the set of one or more active transmission modes may, however, include a (true) subset of all possible transmission modes. In some aspects, the assisting device (such as the vehicular assisting device in the example of FIG. 2) may select a set of one or more active transmission modes. In some examples, the assisting device may further transmit transmission mode set information associated with a set of one or more active transmission modes of the assisting device to the UE. For example, transmission mode set information may be transmitted by RIS controller 230 to UE 215 via local communication link 250. In further aspects, transmission mode set information may be updated by the assisting device, where an updated set may be different from the previous set. In some examples, updates of the transmission mode set may be triggered by the UE. In these cases, the UE transmits a request for updating the set of one or more active transmission modes to the UE via the local communication link. Furthermore, the assisting device may additionally or alternatively trigger an update of the transmission mode set. In such cases, the assisting device may transmit a notification to the UE announcing that an alternative set of active transmission modes is appropriate. In some examples, the assisting device may provide a forecast associated with certain transmission modes based on a look-up on a coverage map, or based on a machine-learning algorithm, where the assisting device anticipates that, for example, a first one or more transmission modes may deteriorate or become irrelevant while a second one or more transmission modes may improve signal quality at a future time instant or at a future location of the UE. In such cases, the UE may determine to use a different set of active transmission modes, e.g., at least in part the announced alternative set at the forecasted time instance or location, and send a notification or confirmation about the use of the different set of active transmission modes to the assisting device.

The assisting device (such as the vehicular assisting device in the scenario of FIG. 2) may use various methods to determine a set of active transmission modes. In some aspects, the assisting device may be capable of determining characteristics of a present propagation scenario. For example, when the assisting device includes RIS metasurfaces, it may determine a subset of all of its metasurfaces through which significant components of propagation signals may propagate. In the present automotive example, the significant propagation paths may include a line-of-sight component 212 that propagates through front screen 222, and a reflected component 214 that propagates through sunroof screen 226. Hence, the vehicular assisting device may determine those transmission modes as part of the active set of transmission modes (e.g., based on a power threshold) that include some or all RIS states of metasurfaces through which significant components or portions of receive power are expected to propagate (e.g., front screen 222 and sunroof screen 226). In some examples, the states of RIS metasurfaces that do not involve relevant propagation components may be set to an arbitrary value, or a default value. In this case, the number of transmission modes to be considered for the set of active transmission modes may significantly be reduced.

To determine the characteristics of the propagation channel, such as the parameters of relevant propagation components (e.g., vectors indicating directions of incident components of signals of a base station, azimuth and elevation angles of incident components, and/or a relative or absolute receive power of incident components, an indicator of an associated base station, or other descriptors), the assisting device may leverage information gathered from sensors associated with itself, and/or from additional cell and link specific information known at the UE, where in the UE transmits the relevant cell specific and link specific information to the assisting device through the local communication link.

The sensors may include, for example, at least one of a camera, a radar, an ultrasonic sensor, a global navigation satellite system (GNSS) receiver, a transceiver of the communication system with which the Uu link is established, a gyroscope, etc. In an example, the assisting device (such as the vehicular assisting device illustrated in FIG. 2) may maintain a coverage map that includes descriptors of the relevant propagation components as a function of a geographical location. In some examples, the coverage map may be pre-defined (e.g., downloaded from a server), or based on historical data of measurements performed by the UE and fed back to the assisting device. Additionally or alternatively, the assisting device may maintain a geographical map that includes locations of base stations, wherein the assisting device may perform ray tracing algorithms to determine the relevant propagation components at particular geographical locations.

In some examples, the vehicular assisting device (such as the vehicular assisting device illustrated in FIG. 2) may determine a location and orientation of the vehicle (such as vehicle 260) based on sensor data associated with the vehicle and/or the UE (such as UE 215). In some examples, the determination is made based on data received from a GNSS receiver and a gyroscope. To determine location and orientation of the vehicle, the GNSS receiver and/or the gyroscope may be built-in components to the vehicular assisting device. In other examples, the UE (such as UE 215) may provide position and orientation data based on a GNSS receiver included in the UE. In some examples, orientation of the vehicle may be determined based on different samples of location data, assuming that the vehicle is in forward motion. The vehicular assisting device (such as the assisting device illustrated in FIG. 2) may determine the significant propagation paths based on a location of the UE and a look-up in the coverage map. Furthermore, the relevant RIS components (e.g., metasurfaces) associated with the relevant transmission components (e.g., transmission paths) may be determined based on the orientation data. The relevant RIS components may be those penetrated by the relevant propagation paths. For example, the vehicular assisting device associated with the vehicle 260 may determine for a particular geographical location transmission paths 212 and 214. Furthermore, based on the orientation of vehicle 260, the vehicular assisting device may determine that the relevant transmission paths propagate through front screen 222 and sunroof screen 226. Based on the latter determination, the assisting device may determine a set of active transmission modes that includes all different RIS states of the metasurfaces only associated with front screen 222 and sunroof screen 226 (i.e., 4 of the 32 possible transmission modes) while RIS states of left side screen 224, rear screen 228 and the right side screen of vehicle 260 are set to an arbitrary or a defined default value (e.g. a default value blocking the transmission of RF signals). The assisting device may thus determine a reduced set of transmission states based on the determined RIS metasurfaces. In an example, the reduced set of active transmission states includes all transmission states of metasurfaces determined as relevant, while the RIS states of non-relevant metasurfaces are discarded (e.g. set to a default or arbitrary value). In an example, a 5-digit bitmap may be defined for the 32 possible transmission modes associated with the vehicle 260. A particular digit in the bitmap may be associated with a state of a respective RIS surface. In the reduced set of active transmission states, all digits associated with RIS surfaces not illuminated or propagated by the relevant signal component (e.g., transmission path) are set to “0”. On the other hand, the reduced set of active transmission modes may include all combinations of the digit values associated with RIS surfaces illuminated by relevant signal components. In this way, the UE can select (e.g., by performing measurements) an appropriate transmission mode amongst the transmission modes of the reduced set of active transmission modes.

The vehicular assisting device may transmit the transmission mode set information associated with the determined set of active transmission modes to the UE. In some aspects, the transmission mode set information may include transmission mode data sets associated with the determined active transmission modes (such as the 4 determined transmission modes associated with front screen 222 and sunroof screen 226 as provided in the example of FIG. 2). In some aspects, besides the configurations (e.g., RIS states) associated with each transmission mode, the datasets associated with the transmission mode set information may include a signal quality prediction provided by the vehicular assisting device. The signal quality prediction may relate to a relative or absolute receive power at the location of vehicle 260 based on a look-up in the coverage map. In some examples, the prediction may relate to an instantaneous relative or absolute receive power at the location of vehicle 260 based on a look-up in the coverage map. In the present automotive example of FIG. 2, the vehicular assisting device may use the relative or absolute power associated with transmission path 212 from the coverage map for the RIS states associated with front screen 222, and the relative or absolute power associated with transmission path 214 from the coverage map for the RIS states associated with sunroof screen 226. Furthermore, the datasets associated with the transmission mode set information may include a cell or base station identifier associated with the signal quality prediction. This may be useful when the transmission mode set information includes data sets associated with different base stations. The UE may use this information, for example, to perform cell selection, or to transmit handover requests to the base station.

Additionally or alternatively, an assisting device (such as the vehicular assisting device associated with vehicle 260) may use perception and/or machine-learning (ML) based control algorithms to determine or to refine the set of active transmission modes. In an example, camera-based perception may be used, supported by ML-based control algorithms to identify obstacles in the propagation path. For example, the assisting device associated with vehicle 260 may be equipped with a camera and a perception and machine learning engine. In an example, the vehicular assisting device may perceive a truck driving ahead that shadows direct path 212. In reaction, the set of active transmission modes may be reduced to those including all RIS states associated with sunroof screen 226, while the transmission modes for different RIS states associated with front screen 222 are removed from the set of active transmission modes.

Based on perception and/or ML-based control algorithms, a vehicle assisting device may also make forecasts about future propagation components. For example, the algorithm may determine that a propagation path may come up or vanish in the near future, as it is determined that the vehicle 260 approaches or drives away from an ahead driving truck. For such cases, the datasets of the transmission mode set information provided by the vehicle assisting device may include a signal quality forecast associated with the signal quality expected at a future time instant and the corresponding time instant associated with the signal quality forecast (e.g., the forecasted time will be after 5 seconds). Based on this information, the UE may be able to preemptively re-select a transmission mode of the assisting device.

In some examples, the assisting device may include a transceiver to establish a Uu link with at least one base station of the same communication system as UE 215. In an example, vehicle 260 may be equipped with a transceiver that may support the same or different transmission band(s) of the UE. For example, the assisting device may support FR1 transmission band while UE 215 may use a FR2 Uu link. In such cases, the assisting device may use information measured over SSBs or specific CSI-RS from the base station to select or update transmission mode set information. For example, the assisting device may determine the physical cell identifier of one or more neighboring base stations in the FR1 transmission bands and determine a quasi-collocation (QCL) relationship associated with one or more base stations in the FR2 band received from the respective base stations' system information. For example, a signal quality prediction provided by the vehicular assisting device may be based on an SSB and/or CSI-RS measurement in FR1 while UE 215 uses the prediction for an Uu link in FR2. Thus, the assisting device may determine and/or update the set of active transmission modes based on signals of a transceiver of the communication system with which the Uu link of UE 215 is established.

Certain aspects of the present disclosure relate to layer 1 (L1) relays. L1 relays may have many favorable features. For example, such L1 relays are relatively simple, low-cost, low-power, and may be wirelessly connected to a base station (such as a gNB) or another relay. An advantage of L1 relays is that they do not add latency, as they simply amplify and forward a signal. Some L1 relays may use full-duplex mode (e.g., for FDD mode), i.e., one frequency band for downlink, and another one for uplink. Some L1 relays (e.g., TDD mode) may switch between uplink and downlink. New technologies, such as 5G NR may gain considerably from L1 relay deployment, in particular when they are used in combination with mmW communication, where signal attenuation and blocking may create coverage holes.

In some cases, L1 relays are deployed as part of a network infrastructure. While it may be relatively simple to deploy L1 relays that receive a signal on one port to amplify and forward it to a second port, extending this to multi-antenna L1 relays may require enhancements to the architecture as well as additional protocol and interface design for control. There may also be an impact on network planning, as the network may need to handle different sets of beams at a gNB (e.g., a donor gNB) and at an associated L1 relay. Aspects of the present disclosure may relate to coverage enhancements using L1 relays (such as smart repeaters acting as assisting devices managed by a UE) for the mmW band that are independent from such network planning aspects.

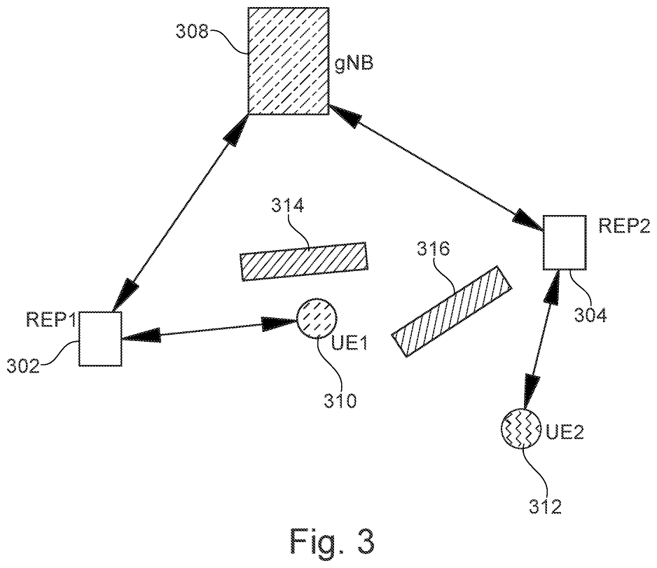

FIG. 3 illustrates one example application of how L1 relays (such as smart repeaters) may be used to help improve coverage by overcoming blockage (for instance, obstruction of RF signals by an object), in accordance with aspects of the present disclosure. It is generally understood that the blockage is a major issue in millimeter wave (mmW) transmissions where beamforming is used to send directional RF signals. In the illustrated example, L1 relays (for example, REP1 302 and REP2 304) may allow a gNB 308 to serve UEs (for example, UE1 310 and UE2 312) even though objects prevent gNB directional RF signals from reaching the UEs.

As illustrated, because the REP1 302 is not blocked by the objects, the REP1 302 may receive the RF signals from the gNB 308 and relay or forward the RF signals to reach the UE1 310 (although the UE1 310 is blocked by the first object 314 from receiving the RF signals directly from the gNB 308). Similarly, because the REP2 304 is not blocked by the objects, the REP2 304 may receive the RF signals from the gNB 308 and relay the RF signals to reach the UE2 312 (although the UE2 312 is blocked by the second object 316 from receiving the RF signals directly from the gNB 308). As demonstrated by this example, L1 relays may serve as relatively simple and inexpensive solutions to provide protection against the blockage by the objects, extend the coverage of a mmW cell, and fill coverage holes.

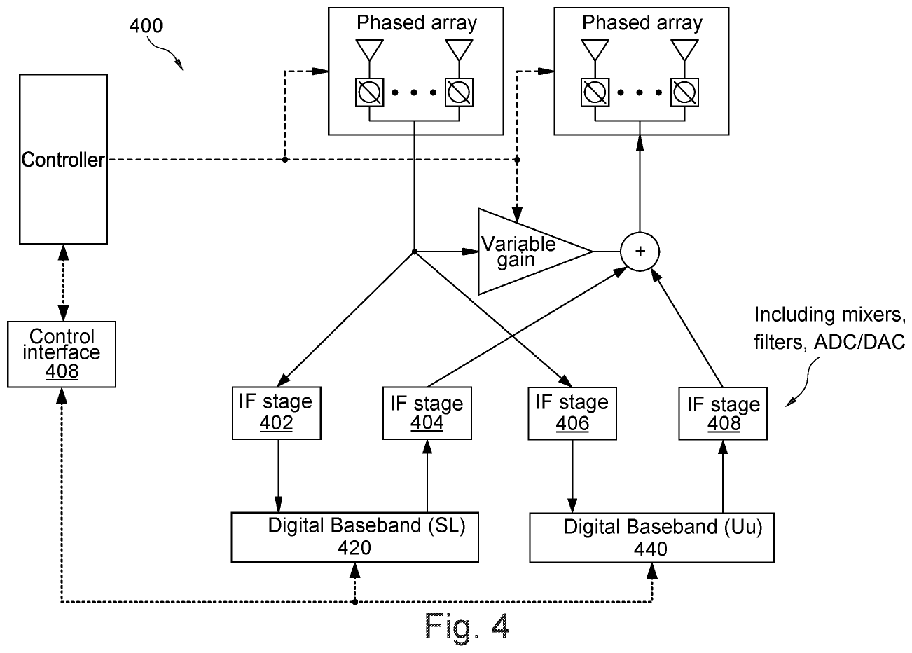

FIG. 4 shows an example architecture 400 for a L1 relay (for example, a smart repeater, or simply denoted as “repeater”, e.g., REP1 or REP2 as of FIG. 4), in accordance with aspects of the present disclosure. As illustrated, the smart repeater may have additional components when compared to a base L1 (layer 1) relay architecture, where the repeater simply amplifies the received RF signal and forwards the RF signal to become the transmitted RF signal (amplify-and-forward). The additional components may allow the smart repeater, for example, to perform beamforming for receiving and/or transmitting RF signals. In some aspects, the smart repeater is an assisting device in accordance with aspects of the present disclosure.

As illustrated, the smart repeater of FIG. 4 may have components that may allow the smart repeater to perform at least limited baseband processing. Such components may include a digital baseband (BB) processor 420 for a local communication link, such as a sidelink between the repeater and another sidelink device (such as a UE 115, in particular UE 112, 114, 116 or 118 of FIG. 1) and optionally a baseband (BB) processor 440 for the Uu link between a UE (such as a UE 115, in particular UE 112, 114, 116 or 118 of FIG. 1) and a base station (with at least limited baseband capability, for example, relative to a sidelink device, UE or base station). While a sidelink is an example of a local communication link, in other examples, a local communication link may be provided by wireless communication techniques, such as Bluetooth, ZigBee, or Wi-Fi.

The components of the smart repeater may also include intermediate frequency (IF) stages (for example, a first IF stage 402, a second IF stage 404, a third IF stage 406 and a fourth IF stage 408) including mixers, filters, analog-to-digital converters (ADCs), digital-to-analog converters (DACs), and the like designed to convert a received RF signal to an IF signal, take and store digital (IQ) samples, and generate the RF signal from the stored digital samples. For this purpose, the smart repeater may include at least sufficient storage to implement a buffer to store the IQ samples.

The smart repeater of FIG. 4 may also include a control interface 408 to receive, demodulate and decode control signaling. In aspects of the present disclosure, the digital baseband (BB) processor 420 for a sidelink may be used to extract control information received from a sidelink device (such as UE 115, in particular UE 112, 114, 116, or 118 in FIG. 1) via a sidelink to control the configuration of the repeater. The flow of control information is illustrated in FIG. 4 as dashed lines. In optional aspects, the control interface may be configured to receive, demodulate and decode signals of the Uu link via a digital BB processor 440 for the Uu link. In some aspects, the smart repeater does not include a digital BB processor 440 for the Uu link.

In an aspect, the smart repeater may include at least one phased array antenna for receiving directional signals (e.g., receive beams), and a phased array for transmitting directional signals (e.g., transmit beams). The configuration may include a band, a bandwidth part (BWP), or a frequency range at which the smart repeater may receive, amplify and transmit (i.e., forward) signals associated with an Uu link, a band, a bandwidth part (BWP), or a frequency range at which the smart repeater may receive and transmit signals associated with a sidelink, wherein the sidelink signals and the Uu link signals may be on different bands or bandwidth parts within a same frequency range. The repeater may therefore amplify and forward uplink and downlink signals of a Uu link. Furthermore, the repeater may receive signals on a sidelink (such as control signals), and transmit signals on a sidelink (such as feedback signals or sequences). The smart repeater may not have an implementation of a full communications stack. In particular, for reasons of simplicity, the repeater may not have upper layer protocol stacks implemented, such as MAC, PLC, PDCP or application layer. In aspects, the repeater may be configured to decode sequences and signals (such as control signals) on the physical layer associated with the sidelink via IF stage 402, so as to perform the functionality as described herein.

In some implementations, the digital BB processor 420 or 440 may produce an output to an IF stage (for example, to the second IF stage 404 or to the fourth IF stage 408) that gets summed via branches with a respective analog transmit path. These branches may be used to sum the signal coming from a gNB (and going to a UE) with any locally generated signal that the smart repeater has to concurrently send to a UE. In aspects, the smart repeater may transmit a sidelink signal (such as a feedback signal or sequence) concurrently with an Uu signal originating from a gNB forwarded on the downlink towards a UE. In other aspects, the smart repeater may receive a sidelink signal (e.g., including communication to select a transmission mode of the repeater) via IF stage 402, and concurrently forward Uu link signals towards a gNB. The time duplexing for transmitting and receiving signals on the Uu link, and the time duplexing for transmitting and receiving signals on the sidelink may be managed by the UE. In some aspects, the gNB may be base station 105 of FIG. 1, and the UE may be UE 115, for example, UE 112, 114, 116 and 118 according to FIG. 1.

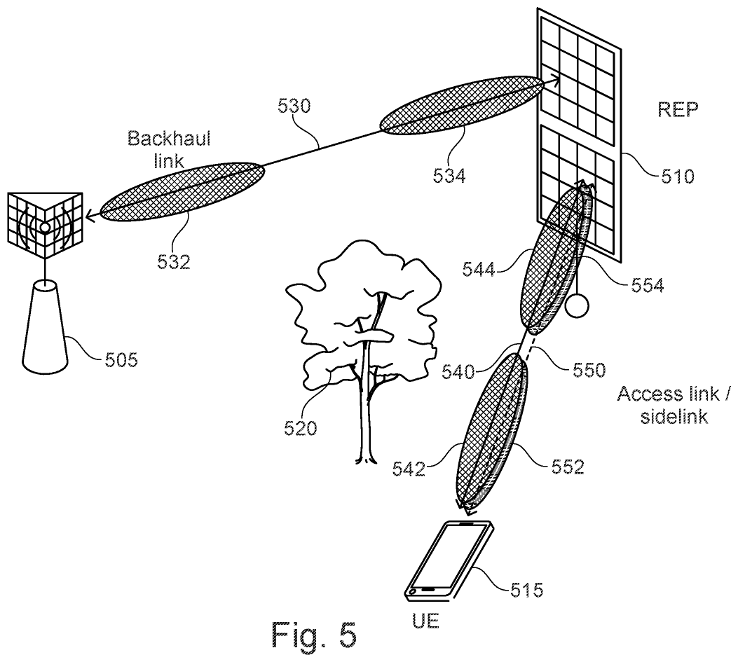

FIG. 5 illustrates an example application of an assisting device based on a smart repeater in accordance with aspects of the present disclosure. The smart repeater REP may be REP1 402 or REP2 404 according to FIG. 4 (e.g., corresponding to the smart repeater architecture 400 in accordance with FIG. 4). In an aspect, REP may forward signals of a Uu link from/to gNB 505 (which may correspond to BS 105 of FIG. 1) to/from UE 515 (which may correspond to UE 115, in particular UE 112, 114, 116, 118 of FIG. 1). In an aspect, UE 515 may be represented by a first sidelink device 312, and REP 510 may be represented by a second sidelink device 314 as illustrated in FIG. 3. Further in FIG. 5, the Uu link may be forwarded via backhaul link 530 between gNB 505 and REP 510, and via access link 540 between REP 510 and UE 515, to mitigate blocking of an obstacle 520. Backhaul link 530 may be formed by gNB beam 532 and repeater backhaul link beam 534. The different beams steerable as repeater backhaul link beam 534 may constitute transmission modes associated with smart repeater assisting device 510 for relaying radio signals associated with the Uu link between UE 515 and gNB 505. Access link 540 may be formed by repeater access link beam 544 and UE beam 542. The backhaul link 530 and the access link 540 may refer to downlink as well as to uplink transmissions between gNB 505 and UE 515. The repeater 510 may be used with both frequency division duplexing (FDD) and time division duplexing (TDD) for the sidelink and the Uu link.

The repeater REP 510 may be controlled via sidelink 550. While a sidelink is an example of a local communication link, in other examples, a local communication link may be provided by wireless communication techniques, such as Bluetooth, ZigBee, or Wi-Fi. The sidelink signals and the Uu link signals may be on different bands or bandwidth parts within a same frequency range. In some aspects, the sidelink 550, even though separated from the Uu link in frequency, may utilize the same beams at the repeater 510 and the UE 515 as the access link. There may be thus a quasi-colocation relationship (QCL) between repeater access link beam 544 and the corresponding repeater sidelink beam 554. Furthermore, there may be a QCL between the UE access link beam 542 and corresponding UE sidelink beam 552. In such cases, sidelink beam management may be used for managing access link beams. Repeater 510 may, for example, have one or more antenna arrays for transmitting, and another one or more antenna arrays for receiving. Thus, in these examples, the antenna arrays may be shared for transmissions on backhaul link 530, access link 540, and sidelink 550. In other configurations, repeater 510 may include one or more antenna arrays for transmissions on backhaul link 530, and another one or more antenna arrays for transmissions on access link 540 and/or sidelink 550. In such configurations, e.g., a switching mechanism within repeater 510 may direct signals between antenna arrays and amplifier inputs/outputs for transmitting/receiving on links 530, 540 and 550, respectively.

Controlling the repeater 510 via sidelink by a sidelink-capable UE 515 decouples the repeater from network planning. Repeater 510 may thus be transparent to gNB 505, and appear to gNB 505 as a signal reflecting point (e.g., a wall or a physical scatterer) for the Uu link related signals. In some aspects, the repeater may not be regarded as part of the network-side equipment. Examples of deployment of a smart repeater such as repeater 510 may include mitigation of coverage holes at the user's residence. As another example, repeater 510 may be deployed in a vehicle for communication between a base station 505 and a UE located in the interior. Many other deployment examples are conceivable. In aspects, repeater 510 may provide a radio propagation path via a reflection point in addition to a line-of-sight path between UE 515 and gNB 505 (not shown in FIG. 5) to facilitate additional reliability and/or diversity enhancement of the Uu link. In some aspects, the number of repeater backhaul link beams and repeater access link beams may be the same, or different. In a non-limiting example, smart repeater assisting device 510 supports a single access link (or sidelink) beam (or fix directional antenna pattern) of relatively large width (e.g., of an omnidirectional configuration, of 360 degrees or less, 180 degrees, 120 degrees, etc.). This may be sufficient to enhance network coverage for deployments in which the distance between UE 515 and the repeater 510 is relatively short compared to the distance between repeater 510 and gNB 505.

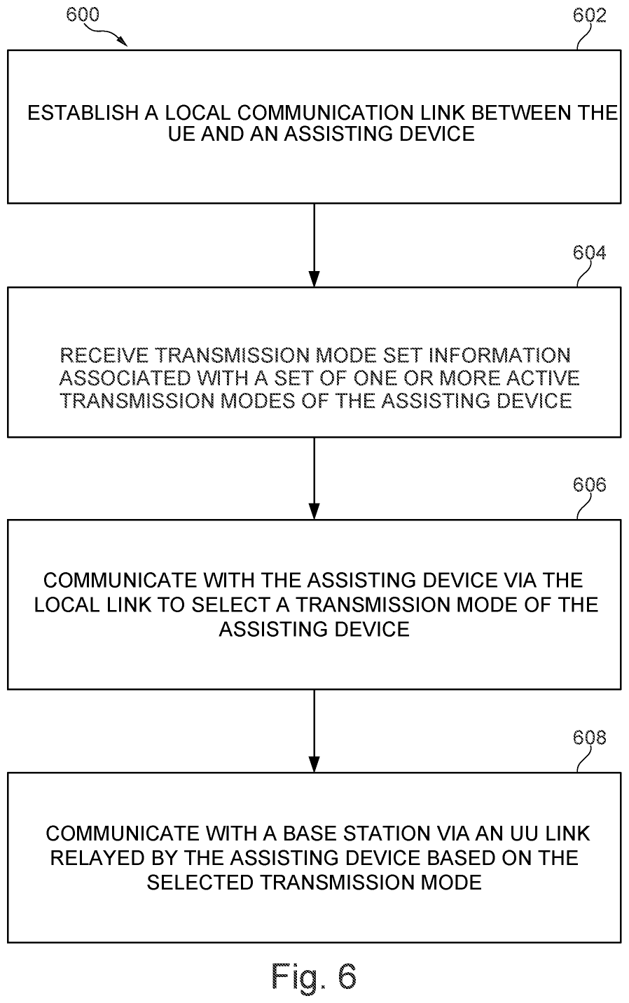

FIG. 6 illustrates example operations that may be performed by a UE being configured for communicating with an assisting device, in accordance with certain aspects of the present disclosure. In some aspects, the UE may be a UE 115 of FIG. 1, being configured for managing an assisting device, such as a vehicular assisting device located in vehicle 260 including RIS metasurfaces and a RIS controller 230, an assisting device based on a smart repeater, such as smart repeater 510, or the like. The assisting device may provide different transmission modes for relaying radio signals associated with a Uu link between the UE and a base station. Relaying of radio signals may include redirecting, amplifying and focusing, as described above. In some aspects, the UE may be configured for communicating with the assisting device via a local link provided by wireless communication techniques, such as 3GPP sidelink communications, Bluetooth, ZigBee, or Wi-Fi, to name a few. In some aspects, the UE may be UE 215 of FIG. 2, located in a vehicle, or UE 515 of FIG. 5. The base station may be base station 205 or base station 505.

Operations 600 begin, at 602, by establishing a local communication link between the UE and the assisting device. At 604, the UE may receive transmission mode set information associated with a set of one or more active transmission modes of the assisting device. At 606, the UE may communicate with the assisting device via the local link to select a transmission mode of the assisting device. At 608, the UE may communicate with the base station via an Uu link related by the assisting device based on the selected transmission mode. By establishing a local communication link between the UE and the assisting device for relaying an Uu link, the UE can use the local communication link to control or manage the assisting device. Thereby, the assisting device may become part of the UE, seen from network perspective. In some aspects, procedures for measuring the channel, including beam management, may rely on procedures existing in the network. Therefore, network support for integrating UE-controlled assisting devices may be minimal or may not be required at all.

By receiving transmission mode set information associated with a set of one or more active transmission modes of the assisting device, the UE becomes aware of the transmission modes offered by the assisting device. In some examples, the UE may communicate with the assisting device via the local link to select a transmission mode of the assisting device. For example, the UE may select or re-select, from the set of one or more active transmission modes, a transmission mode of the assisting device. Thus, communication with the assisting device may include an indication of the transmission mode selected by the UE. In some cases, the UE may communicate with the assisting device via the local link to trigger measurements on the Uu link. Such communication may include settings of transmission modes for measurements to support a selection of an appropriate transmission mode of the set of one or more active transmission modes. In some cases, the UE may transmit additional information, such as a signal quality measured by the UE at a certain location with a certain cell. Such information may be used at the assisting device to update or improve a coverage map. Additionally, a UE may transmit a request for an update of the transmission mode set information from the assisting device. Such update request may be used when the UE notifies a significant degradation of signal quality on the Uu link while the location of the UE has changed. In some cases, the UE may receive an update of the transmission mode set information. Such updates may be triggered by a request from the UE, or triggered by the assisting device itself (e.g., based on results of sensor-based perception and machine learning capabilities of the assisting device). Based on the selected transmission mode, the UE may communicate with the base station via the Uu link relayed by the assisting device. This communication may include transmitting and receiving of Uu link data and control signals.

Additionally or alternatively, the operations may further comprise transmitting, via the local link, a configuration of one or more measurement intervals to the assisting device, wherein each of the one or more measurement intervals is associated with a transmission mode of the set of one or more active transmission modes of the assisting device, performing respective one or more measurements on the Uu link of a received signal quality during the one or more measurement intervals, selecting a transmission mode based on the one or more measurements of a received signal quality, and transmitting, via the local link, an indication of the selected transmission mode.

In in these aspects, the UE may transmit a configuration of one or more measurement intervals to the assisting device to facilitate measurements on the Uu link. In some examples, those measurements may be used to select an appropriate transmission mode of the assisting device. In some examples, a first transmission mode of the set of one or more active transmission modes is associated with a first measurement interval, while a second transmission mode may be associated with a second measurement interval. In this way, the assisting device is configured to set a corresponding transmission mode during the respective associated measurement intervals. In an example, the measurement intervals may consecutively follow one after the other, in some cases with a guard interval to allow the assisting device to switch from one transmission mode to the next. In other examples, each of the measurement intervals may be individually configured by the UE at irregular time instances. After one or more measurement intervals are configured, the UE may perform respective one or more measurements on the Uu link. In some examples, the one or more measurements include a received signal quality. For example, the measurements may include at least one SSB configured by the base station. In other examples, the measurements may be based on reference signals, such as CSI-RS transmitted by the base station. In other examples, the one or more measurements may include transmission of one or more signals on the Uu uplink, where the base station receives the signals and performs corresponding measurements of the transmission channel. A transmission mode may be selected based on the one or more measurements. In some examples, the transmission mode may be from the set of one or more active transmission modes of the assisting device. The measurements may include a received signal quality, such as reference signal received power (RSRP), signal-to-noise ratio (SNR), signal to interference and noise ratio (SINR), channel quality indicators (CQI), and the like. For measurements performed on the Uu uplink, the UE may receive an associated feedback by the base station on the Uu link. In some examples, the base station may direct the UE to use a particular transmission mode. It should be noted that the measurements are end-to-end measurements, i.e., the measurements include the entire Uu link. In some cases, the UE may select a transmission mode based on the measurements and transmit an indication of the selected transmission mode via the local link to the assisting device to perform communication via the Uu link.

Additionally or alternatively, the operations may further comprise determining that a received signal quality on the Uu link has degraded, selecting a different transmission mode for the assisting device, and transmitting, via the local link, an indication of the selected different transmission mode. In this way, the UE may react to improve link quality when channel conditions are subject to time-variant changes. In an example, the selected transmission mode may be associated with a measurement of a signal quality obtained from previous measurements. In some other examples, the UE may configure one or more measurement intervals and perform measurements on the configured measurement intervals, as described above.

Additionally or alternatively, the operations may further comprise receiving, via the Uu link, an indication of one or more measurement intervals, and determining the configuration of one or more measurement intervals based on the indication. In some cases, the measurements involve interactions with the base station. For example, the base station may need to configure corresponding measurement intervals to transmit CSI-RS. In some examples, the UE may transmit a request to the base station for configuring the one or more measurement intervals. Thereby, existing measurement procedures (e.g., P1, P2 or P3 procedures) may be re-used for selecting an appropriate transmission mode. In some aspects, the indication may be associated with a beam repeatedly (e.g., periodically) transmitted by the base station. Such cases may allow, for example, to use a P3 procedure to adapt or refine the transmission mode of the assisting device.

Additionally or alternatively, the transmission mode set information comprises information on at least one transmission mode dataset associated with a transmission mode of the assisting device. Thereby, each transmission mode may be associated with a transmission mode data set to exchange information about transmission modes between the UE and the assisting device. Data sets may be used to inform the UE about transmission modes of the assisting device. For example, the assisting device may inform the UE about how many active transmission modes are configured in the set of one or more active transmission modes. In other examples, the data sets may be used to provide the assisting device with information from the UE (e.g., feedback) about certain transmission modes. Each transmission mode data set associated with a transmission mode of the assisting device may include one or more information elements. Some of the information elements supported by a transmission mode set may be optionally included.

As an example, the transmission mode data set may comprise indications of a configuration of a transmission mode at the assisting device. This may, for example, include an indication of a type of a transmission mode. For example, for RIS-based transmission modes, each of the transmission modes may be unrelated with regard to another transmission mode of the set. On the other hand, when transmission modes are based on transmit or receive beams at the assisting device, there may be some neighborhood relationship between different transmission modes in that the first transmission mode and a second transmission mode address neighboring beams, e.g., within a beam sweep. In such cases, measurements with regard to transmission modes may be accelerated, for example, by selecting a reduced set of neighboring transmission modes. In examples, the indications of the configuration of a transmission mode may include RIS state information. In examples, the indications of the configuration of a transmission mode may include beamforming information, such as a beam width or a direction of a beam associated with a transmission mode.

As a further example, the transmission mode data set may comprise a signal quality measured by the UE, a cell identifier associated with the measured signal quality, and/or a UE location determined by the UE. Such information may be used, for example, at the assisting device to update or improve a coverage map with of measurements performed by the UE. Furthermore, the data may be used to improve machine learning algorithms implemented at the assisting device for selection of appropriate sets of one or more active transmission modes associated with a certain UE location.

As a further example, the transmission mode data set may comprise a signal quality prediction provided by the assisting device and/or a cell identifier associated with the signal quality prediction. The signal quality prediction and/or a cell identifier associated with the signal quality prediction may relate to an instantaneous signal quality prediction and/or an instantaneous cell identifier, e.g., expected at an instantaneous location of the UE. Such data may be used at the UE, for example, to select an appropriate transmission mode of a set of active transmission modes, for example when UE determines that a received signal quality on the Uu link has degraded. In such cases, the UE may select one of the other transmission modes of which an acceptable signal quality can be expected, e.g., a transmission mode based on a signal quality prediction provided by the assisting device based on a coverage map look-up, or based on machine learning capabilities of the assisting device. Additionally or alternatively, the transmission mode data set may comprise a signal quality forecast provided by the assisting device. The signal quality forecast may be associated with a signal quality expected at a future time instant or location of the UE. Additionally or alternatively, the transmission mode data set may comprise a signal quality forecast time instant indicating a time instant associated with the signal quality forecast. Based on a forecast, the UE may select or schedule a change of the transmission mode. For example, a forecast associated with certain transmission modes may be based on a look-up on a coverage map, where the assisting device anticipates that, for example, first one or more transmission modes may deteriorate while second one or more transmission modes may improve signal quality at a future time instant or at a future location of the UE. In an example, the signal quality forecast and the corresponding time instant may be based on results obtained with a perception and machine learning engine. For example, a sensor (e.g. a camera and respective signaling processing) may perceive a truck driving ahead of a vehicle including the assisting device. The machine learning engine may forecast that the direct path may disappear after expiry of a forecasted time interval. In that case, a different transmission mode may be more appropriate. Correspondingly, the assisting device may transmit transmission mode set information including a signal quality forecast for a first one or more transmission modes that is in use by the assisting device (e.g., active), and/or second one or more transmission modes that may provide a better signal quality after the forecasted time interval. Based on this information, the UE may schedule a change of transmission modes after expiry of the forecasted time interval.

Additionally or alternatively, the operations may further comprise receiving an update of the transmission mode set information from the assisting device. In some examples, the update may indicate a modification of one or more active transmission modes of the assisting device. The update may include the entire transmission mode set information. In some examples, the set of active transmission modes of the assisting device may be updated only in part. For example, the update may only include one or more information elements that are subject to a change. By receiving an update, the UE may be informed about changes or modifications in the propagation environment as determined by the assisting device, e.g., by look-up in a coverage map, or by results of a perception-based technique as described above. Additionally or alternatively, the operations may further comprise transmitting a request to the assisting device for an update of the transmission mode set information. In some examples, the request for an update of the transmission mode set information may include at least one of a UE location determined by the UE, signal quality measured by the UE, or a cell identifier associated with the measured signal quality. While it is possible that transmission of an update of the transmission mode set information is triggered by the assisting device, it may also be useful that such updates are triggered by the UE. In the latter cases, the UE may transmit a request to the assisting device for an update of the transmission mode set information, for example, when it determines that the received signal quality on the Uu link has degraded. The request for an update of the transmission mode set information may include a UE location determined by the UE (e.g., by means of a GNSS). Such information may be used by the assisting device to determine the UE position. Furthermore, the request for an update may include a signal quality measured by the UE, and/or a cell identifier associated with a signal quality measured at the UE. Such information may be used by the assisting device to provide an appropriate update of the transmission mode set information. In an example, the assisting device may determine updated transmission mode set information based on the identifier of the cell that serves the UE.

In some examples, the assisting device with regard to operations 600 may be a vehicle-mounted device (such as the assisting device described with reference to FIG. 2) comprising one or more transparent and/or reflective reconfigurable intelligent surfaces (RIS) for relaying said radio signals associated with the Uu link between the UE and the at least one base station, a transceiver for communicating with the UE via the local link, a RIS controller for controlling the different transmission modes, wherein said transmission modes comprise transmission, focal and/or reflection modes of the one or more RIS, wherein the local communication link between the UE and the assisting device comprises one of a wireless link, an IEEE 802.11 link, a Bluetooth link, or a 3GPP sidelink.

In other examples, the assisting device regard to operations 600 may be a repeater (such as the repeater described with reference to FIGS. 3, 4 and 5) adapted to perform repeater-sided beamforming on the backhaul part of a Uu link towards a base station, wherein the transmission modes are associated with one or more repeater backhaul link beams, wherein the local communication link between the UE and the assisting device comprises one of a wireless link, an IEEE 802.11 link, a Bluetooth link, or a 3GPP sidelink.

In some examples, the assisting device regard to operations 600 may be a vehicle-mounted device (such as the assisting device described with reference to FIG. 2) comprising one or more sensors comprising one of a camera, a radar, or a global navigation satellite system (GNSS) receiver, a transceiver to establish a Uu link with at least one base station, one of a coverage map including base station coverage information and/or a perception and a machine learning (ML) engine for processing signals of the one or more sensors to determine the set of one or more active transmission modes of the assisting device.

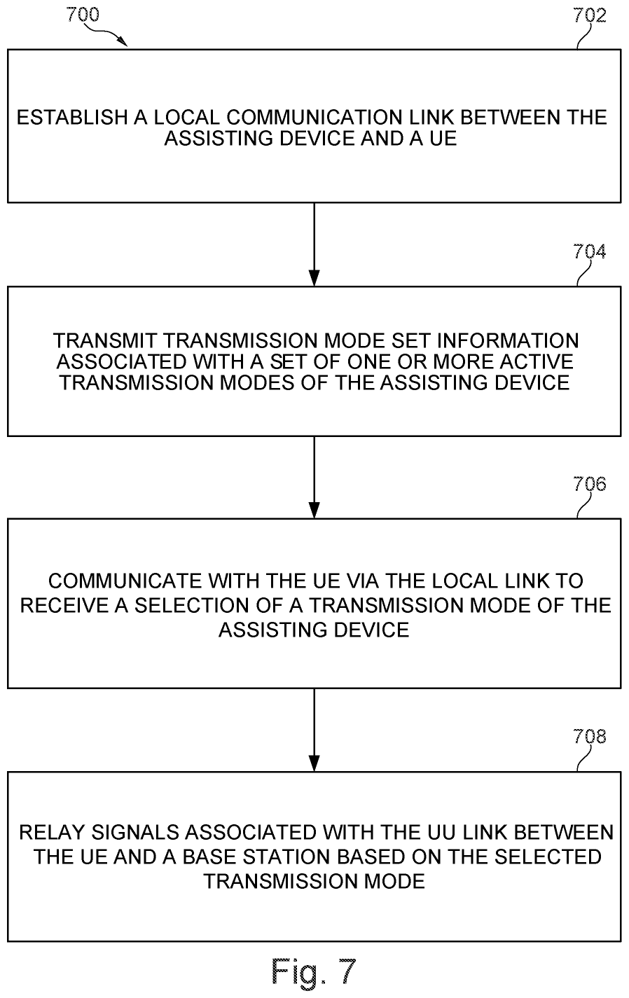

FIG. 7 illustrates example operations that may be performed by an assisting device, in accordance with certain aspects of the present disclosure. The assisting device may provide different transmission modes for relaying radio signals associated with a Uu link between a user equipment (UE) and a base station. In some aspects, the assisting device may be based on reconfigurable intelligent surfaces (RIS) in accordance with aspects of the present disclosure. In some examples, the assisting device may comprise one or more RIS forming respective metasurfaces (such as metasurfaces 222, 224, 226 and 228 as shown in FIG. 2), and an RIS controller (such as RIS controller 230 as shown in FIG. 2). In some examples, the assisting device may include a vehicular assisting device located in vehicle 260 as shown in FIG. 2. In some examples, the assisting device may comprise a UE-controlled repeater (such as repeater 510 of FIG. 5). In some cases, the assisting device may provide different transmission modes for relaying radio signals associated with a Uu link between a UE and a base station. In some aspects, the UE may be configured for communicating with the assisting device via a local link provided by wireless communication techniques, such as 3GPP sidelink communications, Bluetooth, ZigBee, or Wi-Fi, to name a few. In some aspects, the UE may be UE 215 of FIG. 2, located in a vehicle, or UE 515 of FIG. 5. The base station may be, for example, base station 205 or base station 505.

Operations 700 may begin, at 702, by establishing a local communication link between the assisting device and the UE. At 704, the assisting device may transmit transmission mode set information associated with a set of one or more active transmission modes of the assisting device. At 706, the assisting device may communicate with the UE via the local link to select a transmission mode of the assisting device. At 708, the assisting device may relay signals associated with the Uu link between the UE and the base station based on the selected transmission mode.

By establishing a local communication link between the UE and the assisting device, the UE can make use of services provided by the assisting device. By transmitting transmission mode set information associated with a set of one or more active transmission modes of the assisting device, the UE becomes aware of the active transmission modes associated with the assisting device. In an example, transmission modes may be associated with different transfer states of RIS metasurfaces for RIS-based assisting devices. In a further example, transmission modes may be associated with different beams towards a backhaul link between base station and assisting device. Thereby, by using a set of active transmission modes, known procedures, such as beam management procedures, may be reusable for assisting devices based on RIS.

Furthermore, different numbers of transmission modes supported by assisting devices of different types (an RIS-based assisting device, a UE-controlled repeater, etc.) may be handled in a same way. Furthermore, a number of active transmission modes may be less or equal than a number of transmission modes supported by an assisting device. In some optional examples, assisting devices may support determining or selecting a set of one or more active transmission modes that may be less than a number of overall supported transmission modes. For example, an assisting device may (pre-)select transmission modes based on expected signal quality (such as RSRP) on the Uu link. In this way, complexity is reduced, as the number of transmission modes the UE needs to handle can be limited. In some examples, the assisting device may be capable of determining characteristics of a present location-dependent propagation scenario. In an example, the assisting device may maintain a coverage map that includes descriptors of the relevant propagation components as a function of a geographical location. In some examples, the coverage map may be pre-defined (e.g., downloaded from a server), or based on historical data obtained from measurements performed and reported to the assisting device by UEs. The assisting device may further comprise sensors for environmental perception that facilitate e.g., a determination of a location and a geometrical orientation of the assisting device relative to the environment. In this way, for example, major propagation paths between a base station and the assisting device may be determined relative to the orientation of the assisting device within the environment. Furthermore, the assisting device may select a set of one or more active transmission modes based on a determination of the major propagation paths. In some examples, the assisting device may select or determine a set of one or more active transmission modes based on environmental perception.

In some examples, environmental perception may be enhanced by a machine learning algorithms. For example, an assisting device may include a camera that notifies that some propagation paths may be obstructed by objects. In some examples, machine learning algorithms may be used to determine the dynamic behavior of a set of one or more active transmission modes. For example, machine learning algorithms may anticipate or forecast when certain transmission paths may occur or vanish in order to update a set of active transmission modes. Thus, transmission mode set information may be time variant, and subject to updates.

The local link may further be used to communicate with the UE to select a transmission mode of the assisting device. In some cases, the assisting device may receive a selection of a transmission mode for Uu link transmissions from the UE, as explained above. Furthermore, the communication may include settings of transmission modes for measurements to support a selection of an appropriate transmission mode of the set of one or more active transmission modes. However, the assisting device may also receive additional information, such as a signal quality measured by the UE at a certain location with a certain cell. Such information may be useful at the assisting device to update or improve a coverage map. Additionally, the assisting device may receive a request for an update of the transmission mode set information. Such updates may be useful when the UE notifies a significant degradation of signal quality on the Uu link while the location of the UE has changed. In this case, the assisting device may transmit an update of the transmission mode set information. Based on the selected transmission mode, the assisting device may relay signals associated with the Uu link.

Additionally or alternatively, the operations may further comprise receiving, via the local link, a configuration of one or more measurement intervals from the UE, wherein each of the one or more measurement intervals is associated with a transmission mode of the set of one or more active transmission modes of the assisting device, setting respective one or more transmission modes during the one or more measurement intervals, receiving, via the local link, an indication of the selected transmission mode, and setting the selected transmission mode for relaying signals associated with the Uu link. In this way, the assisting device may support measurements of different transmission modes on the Uu link under the control of the UE to select an appropriate transmission mode for the Uu link, as described above.

Additionally or alternatively, the operations may further comprise receiving, via the local link, an indication of a selected different transmission mode, setting the different transmission mode for relaying signals associated with the Uu link. In this way, the assisting device may be managed by the UE to react to time-variant changes of channel conditions experienced on the Uu link.

Additionally or alternatively, the transmission mode set information may comprise information on at least one transmission mode dataset associated with a transmission mode of the assisting device, the transmission mode dataset comprising indications of at least one of a configuration of a transmission mode at the assisting device, a signal quality measured by the UE, a cell identifier associated with the measured signal quality, a UE location determined by the UE, a signal quality prediction provided by the assisting device, a cell identifier associated with the signal quality prediction, a signal quality forecast provided by the assisting device, the signal quality forecast being associated with a signal quality expected at a future time instant, or a signal quality forecast time instant indicating a time instant associated with the signal quality forecast, as described above, to exchange information about transmission modes between the UE and the assisting device.

Additionally or alternatively, the operations may further comprise transmitting an update of the transmission mode set information to the UE. The update may indicate a modification of one or more active transmission modes of the assisting device. In some examples, the update may be triggered by a location update determined by a GNSS receiver of the assisting device. In some other examples, the update may be triggered by a location update received from the UE. In some examples, the assisting device may receive a request to from the UE for an update of the transmission mode set information. The request for an update of the transmission mode set information includes at least one of a UE location determined by the UE, a signal quality measured by the UE, or a cell identifier associated with the measured signal quality, as discussed above.

In some examples, the assisting device with regard to operations 700 may be a vehicle-mounted device (such as the assisting device described with reference to FIG. 2) comprising one or more transparent and/or reflective reconfigurable intelligent surfaces (RIS) for relaying said radio signals associated with the Uu link between the UE and the at least one base station, a transceiver for communicating with the UE via the local link, a RIS controller for controlling the different transmission modes, wherein said transmission modes comprise transmission and/or reflection modes of the one or more RIS, wherein the local communication link between the UE and the assisting device comprises one of a wireless link, an IEEE 802.11 link, a Bluetooth link, or a 3GPP sidelink.

In other examples, the assisting device with regard to operations 700 may be a repeater (such as the repeater described with reference to FIGS. 3, 4 and 5) adapted to perform repeater-sided beamforming on the backhaul part of a Uu link towards a base station, wherein the transmission modes are associated with one or more repeater backhaul link beams, wherein the local communication link between the UE and the assisting device comprises one of a wireless link, an IEEE 802.11 link, a Bluetooth link, or a 3GPP sidelink.

In some examples, the assisting device with regard to operations 700 may be a vehicle-mounted device (such as the assisting device described with reference to FIG. 2) comprising one or more sensors comprising one of a camera, a radar, or a global navigation satellite system (GNSS) receiver, a transceiver to establish a Uu link with at least one base station, one of a coverage map including base station coverage information and/or a perception and a machine learning (ML) engine for processing signals of the one or more sensors to determine the set of one or more active transmission modes of the assisting device.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Means for receiving or means for obtaining may include a receiver or one or more antenna(s). Means for transmitting or means for outputting may include a transmitter or one or more antenna(s). Means for associating, means for determining, means for monitoring, means for deciding, means for providing, means for detecting, means for performing, and/or means for setting may include a processing system, which may include one or more processors. Such processors may be part of base stations (such as base station 105 of FIG. 1, 205 of FIG. 2, 308 of FIG. 5, and/or 505 of FIG. 5). Such processors may furthermore be part of an assisting device or components thereof (such as RIS controller 230 of FIG. 2, repeaters 302, 304 of FIG. 3, L1 relay 400, and/or repeater (REP) 510). Furthermore, such processors may also be parts of UE's (such as UE 117 of FIG. 1, UE 215 of FIG. 2, UE's 310 and 312 of FIG. 3, and/or UE 515 of FIG. 5).

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 115 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules.

The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or access point as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or access point can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

The following provides an overview of various examples illustrating different aspects in accordance with the present disclosure:
Example 1: A method of wireless communication by a UE, the UE being configured for communicating with an assisting device, the assisting device providing different transmission modes for relaying radio signals associated with a Uu link between the UE and a base station, the method comprising establishing a local communication link between the UE and the assisting device; receiving transmission mode set information associated with a set of one or more active transmission modes of the assisting device; communicating with the assisting device via the local link to select a transmission mode of the assisting device; communicating with the base station via the Uu link relayed by the assisting device based on the selected transmission mode.
Example 2: The method of example 1, further comprising: transmitting, via the local link, a configuration of one or more measurement intervals to the assisting device, wherein each of the one or more measurement intervals is associated with a transmission mode of the set of one or more active transmission modes of the assisting device; performing respective one or more measurements on the Uu link of a received signal quality during the one or more measurement intervals; selecting a transmission mode based on the one or more measurements of a received signal quality; and transmitting, via the local link, an indication of the selected transmission mode.
Example 3: The method of one or more of examples 1 to 2, further comprising determining that a received signal quality on the Uu link has degraded; selecting a different transmission mode for the assisting device; and transmitting, via the local link, an indication of the selected different transmission mode.
Example 4: The method of one or more of examples 1 to 3, further comprising receiving, via the Uu link, an indication of the one or more measurement intervals; and determining the configuration of the one or more measurement intervals based on the indication.
Example 5: The method of one or more of examples 1 to 4, wherein the indication is associated with a beam repeatedly transmitted from the base station.
Example 6: The method of one or more of examples 1 to 5, wherein the transmission mode set information comprises information on at least one transmission mode dataset associated with a transmission mode of the assisting device, the transmission mode dataset comprising indications of at least one of:
   a configuration of a transmission mode at the assisting device;
   a signal quality measured by the UE;
   a cell identifier associated with the measured signal quality;
   a UE location determined by the UE;
   a signal quality prediction provided by the assisting device;
   a cell identifier associated with the signal quality prediction;
   a signal quality forecast provided by the assisting device, the signal quality forecast being associated with a signal quality expected at a future time instant; and/or
   a signal quality forecast time instant indicating a time instant associated with the signal quality forecast.
Example 7: The method of one or more of examples 1 to 6, further comprising receiving an update of the transmission mode set information from the assisting device.
Example 8: The method of one or more of examples 1 to 7, wherein the update indicates a modification of one or more active transmission modes of the assisting device.
Example 9: The method of one or more of examples 1 to 8, further comprising transmitting a request to the assisting device for an update of the transmission mode set information.
Example 10: The method of one or more of examples 1 to 9, wherein the request for an update of the transmission mode set information includes at least one of:
   a UE location determined by the UE;
   a signal quality measured by the UE; and/or
   a cell identifier associated with the measured signal quality.
Example 11: The method of one or more of examples 1 to 10, wherein the assisting device is a vehicle-mounted device comprising one or more sensors comprising one of a camera, a radar, or a global navigation satellite system (GNSS) receiver, a transceiver to establish a Uu link with at least one base station; and one of a coverage map including base station coverage information and/or a perception and machine learning (ML) engine for processing signals of the one or more sensors to determine the set of one or more active transmission modes of the assisting device.
Example 12: The method of one or more of examples 1 to 11, wherein the assisting device is a vehicle-mounted device comprising one or more transparent and/or reflective reconfigurable intelligent surfaces (RIS) for relaying said radio signals associated with the Uu link between the UE and the at least one base station; a transceiver for communicating with the UE via the local link; a RIS controller for controlling the different transmission modes, wherein said transmission modes comprise transmission and/or reflection modes of the one or more RIS; and wherein the local communication link between the UE and the assisting device comprises one of an IEEE 802.11 link, a Bluetooth link or a 3GPP sidelink.
Example 13: The method of one of the preceding examples 1 to 12, wherein the assisting device is a repeater for relaying said radio signals associated with the Uu link between the UE and the base station, comprising:
a transceiver for communicating with the UE via the local link; and
a repeater controller for controlling the different transmission modes, wherein said transmission modes comprise beam mappings of one or more beams directed towards the base station;
wherein the local communication link between the UE and the assisting device comprises one of a device-to-device link, an IEEE 802.11 link, a Bluetooth link or a 3GPP sidelink.
Example 14: A method of wireless communication by an assisting device, the assisting device providing different transmission modes for relaying radio signals associated with a Uu link between a user equipment (UE) and a base station, the method comprising establishing a local communication link between the assisting device and the UE; transmitting transmission mode set information associated with a set of one or more active transmission modes of the assisting device; communicating with the UE via the local link to select a transmission mode of the assisting device; and relaying signals associated with the Uu link between the UE and the base station based on the selected transmission mode.
Example 15: The method of example 14, further comprising receiving, via the local link, a configuration of one or more measurement intervals from the UE, wherein each of the one or more measurement intervals is associated with a transmission mode of the set of one or more active transmission modes of the assisting device; setting respective one or more transmission modes during the one or more measurement intervals; receiving, via the local link, an indication of the selected transmission mode and setting the selected transmission mode for relaying signals associated with the Uu link.
Example 16: The method of one or more of examples 14 to 15, further comprising receiving, via the local link, an indication of a selected different transmission mode; and setting the different transmission mode for relaying signals associated with the Uu link.
Example 17: The method of one or more of examples 14 to 16, wherein the transmission mode set information comprises information on at least one transmission mode dataset associated with a transmission mode of the assisting device, the transmission mode dataset comprising indications of at least one of:
   a configuration of a transmission mode at the assisting device;
   a signal quality measured by the UE;
   a cell identifier associated with the measured signal quality;
   a UE location determined by the UE;
   a signal quality prediction provided by the assisting device;
   a cell identifier associated with the signal quality prediction;
   a signal quality forecast provided by the assisting device, the signal quality forecast being associated with a signal quality expected at a future time instant; and/or
   a signal quality forecast time instant indicating a time instant associated with the signal quality forecast.
Example 18: The method of one or more of examples 14 to 17, further comprising transmitting an update of the transmission mode set information to the UE.
Example 19: The method of one or more of examples 14 to 18, wherein the update indicates a modification of one or more active transmission modes of the assisting device.
Example 20: The method of one or more of examples 14 to 19, further comprising receiving a request to from the UE for an update of the transmission mode set information.
Example 21: The method of one or more of examples 14 to 20, wherein the request for an update of the transmission mode set information includes at least one of:
   a UE location determined by the UE;
   a signal quality measured by the UE; and/or
   a cell identifier associated with the measured signal quality.
Example 22: The method of one or more of examples 14 to 21, wherein the assisting device is a vehicle-mounted device comprising one or more sensors comprising one of a camera, a radar, or a global navigation satellite system (GNSS) receiver, a transceiver to establish a Uu link with at least one base station; and one of a coverage map including base station coverage information and/or a perception and machine learning (ML) engine for processing signals of the one or more sensors to determine the set of one or more active transmission modes of the assisting device.
Example 23: The method of one or more of examples 13 to 22, wherein the assisting device is a vehicle-mounted device comprising one or more transparent and/or reflective reconfigurable intelligent surfaces (RIS) for relaying said radio signals associated with the Uu link between the UE and the at least one base station; a transceiver for communicating with the UE via the local link; a RIS controller for controlling the different transmission modes, wherein said transmission modes comprise transmission and/or reflection modes of the one or more RIS; and wherein the local communication link between the UE and the assisting device comprises one of an IEEE 802.11 link, a Bluetooth link or a 3GPP sidelink.
Example 24: The method of one or more of examples 14 to 23, wherein the assisting device is a repeater for relaying said radio signals associated with the Uu link between the UE and the base station, comprising: a transceiver for communicating with the UE via the local link; and a repeater controller for controlling the different transmission modes, wherein said transmission modes comprise beam mappings of one or more beams directed towards the base station; wherein the local communication link between the UE and the assisting device comprises one of a device-to-device link, an IEEE 802.11 link, a Bluetooth link or a 3GPP sidelink.
Example 25: An apparatus for wireless communications, comprising means configured for executing the method of anyone of examples 1 to 13.
Example 26: An apparatus for wireless communications, comprising means configured for executing the method of anyone of examples 14 to 24.
Example 27: A computer program comprising instructions to cause the apparatus of example 25 to execute the steps of the method of anyone of examples 1 to 13.
Example 28: A computer program comprising instructions to cause the apparatus of example 26 to execute the steps of the method of anyone of examples 14 to 24.
Example 29: A computer program comprising program instructions which, when the program is executed by a computer, carry out all steps of the method of anyone of examples 1 to 13 or 14 to 24.

1. A method of wireless communication by a UE, the UE being configured for communicating with an assisting device, the assisting device providing different transmission modes for relaying radio signals associated with a Uu link between the UE and a base station, the method comprising:
establishing a local communication link between the UE and the assisting device;
receiving transmission mode set information associated with a set of one or more active transmission modes of the assisting device;
communicating with the assisting device via the local link to select a transmission mode of the assisting device; and
communicating with the base station via the Uu link relayed by the assisting device based on the selected transmission mode.

2. The method of claim 1, further comprising:
transmitting, via the local link, a configuration of one or more measurement intervals to the assisting device, wherein each of the one or more measurement intervals is associated with a transmission mode of the set of one or more active transmission modes of the assisting device;
performing respective one or more measurements on the Uu link of a received signal quality during the one or more measurement intervals;
selecting a transmission mode based on the one or more measurements of a received signal quality; and
transmitting, via the local link, an indication of the selected transmission mode.

3. The method of claim 2, further comprising:
determining that a received signal quality on the Uu link has degraded;
selecting a different transmission mode for the assisting device; and
transmitting, via the local link, an indication of the selected different transmission mode.

4. The method of claim 2, further comprising:
receiving, via the Uu link, an indication of the one or more measurement intervals;
determining the configuration of the one or more measurement intervals based on the indication.

5. The method of claim 4, wherein the indication is associated with a beam repeatedly transmitted from the base station.

6. The method of claim 1, wherein the transmission mode set information comprises information on at least one transmission mode dataset associated with a transmission mode of the assisting device, the transmission mode dataset comprising indications of at least one of:
a configuration of a transmission mode at the assisting device;
a signal quality measured by the UE;
a cell identifier associated with the measured signal quality;
a UE location determined by the UE;
a signal quality prediction provided by the assisting device;
a cell identifier associated with the signal quality prediction;
a signal quality forecast provided by the assisting device, the signal quality forecast being associated with a signal quality expected at a future time instant; or
a signal quality forecast time instant indicating a time instant associated with the signal quality forecast.

7. The method of claim 1, further comprising:
receiving an update of the transmission mode set information from the assisting device;

8. The method of claim 7, wherein the update indicates a modification of one or more active transmission modes of the assisting device.

9. The method of claim 7, further comprising:
transmitting a request to the assisting device for an update of the transmission mode set information.

10. The method of claim 9, wherein the request for an update of the transmission mode set information includes at least one of:
a UE location determined by the UE;
a signal quality measured by the UE; or
a cell identifier associated with the measured signal quality.

11. The method of claim 1, wherein the assisting device is a vehicle-mounted device comprising:
one or more sensors comprising one of a camera, a radar, or a global navigation satellite system (GNSS) receiver, a transceiver to establish a Uu link with at least one base station; and
one of a coverage map including base station coverage information and/or a perception and machine learning (ML) engine for processing signals of the one or more sensors to determine the set of one or more active transmission modes of the assisting device.

12. The method of claim 1, wherein the assisting device is a vehicle-mounted device comprising:
one or more transparent and/or reflective reconfigurable intelligent surfaces (RIS) for relaying said radio signals associated with the Uu link between the UE and the at least one base station;
a transceiver for communicating with the UE via the local link; and
a RIS controller for controlling the different transmission modes, wherein said transmission modes comprise transmission and/or reflection modes of the one or more RIS;
wherein the local communication link between the UE and the assisting device comprises one of a device-to-device link, an IEEE 802.11 link, a Bluetooth link or a 3GPP sidelink.

13. The method of claim 1, wherein the assisting device is a repeater for relaying said radio signals associated with the Uu link between the UE and the base station, comprising:
a transceiver for communicating with the UE via the local link; and
a repeater controller for controlling the different transmission modes, wherein said transmission modes comprise beam mappings of one or more beams directed towards the base station;
wherein the local communication link between the UE and the assisting device comprises one of a device-to-device link, an IEEE 802.11 link, a Bluetooth link or a 3GPP sidelink.

14. A method of wireless communication by an assisting device, the assisting device providing different transmission modes for relaying radio signals associated with a Uu link between a user equipment (UE) and a base station, the method comprising:
establishing a local communication link between the assisting device and the UE;
transmitting transmission mode set information associated with a set of one or more active transmission modes of the assisting device;
communicating with the UE via the local link to select a transmission mode of the assisting device; and
relaying signals associated with the Uu link between the UE and the base station based on the selected transmission mode.

15. The method of claim 14, further comprising:
receiving, via the local link, a configuration of one or more measurement intervals from the UE, wherein each of the one or more measurement intervals is associated with a transmission mode of the set of one or more active transmission modes of the assisting device;
setting respective one or more transmission modes during the one or more measurement intervals;
receiving, via the local link, an indication of the selected transmission mode; and
setting the selected transmission mode for relaying signals associated with the Uu link.

16. The method of claim 15, further comprising:
receiving, via the local link, an indication of a selected different transmission mode; and
setting the different transmission mode for relaying signals associated with the Uu link.

17. The method of claim 14, wherein the transmission mode set information comprises information on at least one transmission mode dataset associated with a transmission mode of the assisting device, the transmission mode dataset comprising indications of at least one of:
a configuration of a transmission mode at the assisting device;
a signal quality measured by the UE;
a cell identifier associated with the measured signal quality;
a UE location determined by the UE;
a signal quality prediction provided by the assisting device;
a cell identifier associated with the signal quality prediction;
a signal quality forecast provided by the assisting device, the signal quality forecast being associated with a signal quality expected at a future time instant; or
a signal quality forecast time instant indicating a time instant associated with the signal quality forecast.

18. The method of claim 14, further comprising:
transmitting an update of the transmission mode set information to the UE.

19. The method of claim 18, wherein the update indicates a modification of one or more active transmission modes of the assisting device.

20. The method of claim 18, further comprising:
receiving a request to from the UE for an update of the transmission mode set information.

21. The method of claim 20, wherein the request for an update of the transmission mode set information includes at least one of:
a UE location determined by the UE;
a signal quality measured by the UE;
a cell identifier associated with the measured signal quality.

22. The method of claim 14, wherein the assisting device is a vehicle-mounted device comprising:
one or more sensors comprising one of a camera, a radar, or a global navigation satellite system (GNSS) receiver, a transceiver to establish a Uu link with at least one base station; and
one of a coverage map including base station coverage information and/or a perception and machine learning (ML) engine for processing signals of the one or more sensors to determine the set of one or more active transmission modes of the assisting device.

23. The method of claim 14, wherein the assisting device is a vehicle-mounted device comprising:
one or more transparent and/or reflective reconfigurable intelligent surfaces (RIS) for relaying said radio signals associated with the Uu link between the UE and the at least one base station;
a transceiver for communicating with the UE via the local link; and
a RIS controller for controlling the different transmission modes, wherein said transmission modes comprise transmission and/or reflection modes of the one or more RIS;
wherein the local communication link between the UE and the assisting device comprises one of a device-to-device link, an IEEE 802.11 link, a Bluetooth link or a 3GPP sidelink.

24. The method of claim 14, wherein the assisting device is a repeater for relaying said radio signals associated with the Uu link between the UE and the base station, comprising:
a transceiver for communicating with the UE via the local link; and
a repeater controller for controlling the different transmission modes, wherein said transmission modes comprise beam mappings of one or more beams directed towards the base station;
wherein the local communication link between the UE and the assisting device comprises one of a device-to-device link, an IEEE 802.11 link, a Bluetooth link or a 3GPP sidelink.

25. An apparatus for wireless communications by a UE, the UE being configured for communicating with an assisting device, the assisting device providing different transmission modes for relaying radio signals associated with a Uu link between the UE and a base station, wherein the apparatus includes at least one processor and a memory, wherein the at least one processor and the memory are configured to:
establish a local communication link between the UE and the assisting device;
receive transmission mode set information associated with a set of one or more active transmission modes of the assisting device;
communicate with the assisting device via the local link to select a transmission mode of the assisting device; and
communicate with the base station via the Uu link relayed by the assisting device based on the selected transmission mode.

26. An apparatus for wireless communications by an assisting device, the assisting device providing different transmission modes for relaying radio signals associated with a Uu link between a user equipment (UE) and a base station, wherein the apparatus includes at least one processor and a memory, wherein the at least one processor and the memory are configured to:
establish a local communication link between the assisting device and the UE;
transmit transmission mode set information associated with a set of one or more active transmission modes of the assisting device;
communicate with the UE via the local link to receive a selection of a transmission mode of the assisting device; and
relay signals associated with the Uu link between the UE and the base station based on the selected transmission mode.
